(19) United States
(12) Patent Application Publication
(10) Pub. No.: US 2011/0032259 A1
(43) Pub. Date: Feb. 10, 2011

(54) METHOD OF DISPLAYING IMAGES OBTAINED FROM AN IN-VIVO IMAGING DEVICE AND APPARATUS USING SAME

(75) Inventors: TAE KWON KIM, Gyeonggi-do (KR); DONG HA LEE, Gyeonggi-do (KR); Heung Gil BAE, Seoul (KR)

Correspondence Address: William Park & Associates LTD., 930 N. York Road, Suite 201, Hinsdale, IL, 60521, US

(73) Assignee: INTROMEDIC CO., LTD., Seoul (KR)

(21) Appl. No.: 12/785,427

(22) Filed: May 22, 2010

(30) Foreign Application Priority Data
Jun. 9, 2009 (KR) 10-2009-0051193
Jun. 10, 2009 (KR) 10-2009-0051226
Jun. 10, 2009 (KR) 10-2009-0051237

(51) Int. Cl. G06T 17/00

(52) U.S. Cl. 345/428

(57) ABSTRACT

The present invention relates to a method of displaying images obtained from an in-vivo imaging device, comprising receiving data of original images captured by an in-vivo imaging device in a body lumen; creating simplified images from the original images, the simplified images having lower resolution than the original images; and displaying at least one map view which has a plurality of columns and a plurality of rows, at least part of the map view being filled with the plurality of the simplified images in rows and columns, whereby a user can recognize at a glance if there is any disease such as bleeding before scrutinizing captured images one by one.

### CROSS REFERENCE TO RELATED APPLICATION

This application claims priority to and the benefit of Korean Patent Application Nos. 10-2009-0051193, 10-2009-0051226 and 10-2009-0051237 filed on Jun. 9, 2009, Jun. 10, 2009 and Jun. 10, 2009 respectively in the Korean Intellectual Property Office, the entire contents of which are incorporated herein by reference.

### FIELD OF THE INVENTION

The present invention relates to a method of displaying images obtained from an in-vivo imaging device, more particularly, to such a method of arranging images as a space configuration on a map view having plural rows and plural columns instead of time-dependently arranging images thereby enabling to recognize at a glance what disease is suspected.

### DESCRIPTION OF THE RELATED ART

The digestive organs of a human body are comprised of the esophagus, stomach, small intestines such as the duodenum, ileum, and some other different organs including the colon. In order to examine these interior digestive organs, a capsule endoscope is used to visually diagnose the digestive organs with reducing the examinee's pain.

As illustrated in FIG. 1, the capsule endoscope 30 comprises a light emitting diode (LED) and a micro camera. The light emitting diode lightens the interior of the internal organs 41, and the micro camera takes photographs of digestive organs. Then, the images of digestive organs obtained by the capsule endoscope are wirelessly transmitted to a receiver on which the examinee has. The transmitted image data is transmitted to a processing system 1, and the expert analyzes the images and diagnoses the condition of illness.

Herein, the images of digestive organs taken by the capsule endoscope 30 are over tens of thousands to hundreds of thousands of images dependent on the capability of the capsule endoscope. It is burdensome and time-consuming job for doctors to check every images of the enormous amount of the images keeping concentration so that the huge amount of the images has caused to obstruct the effective and accurate diagnosis of the illness.

Here, the doctor should wait for a long time to examine images displayed in the capturing order with low concentration so that the doctor may fail to catch relevant images which is much important to diagnose a disease and thus may lead to an erroneous diagnosis.

Moreover, in order to reexamine the disease-suspected images, doctors have no choice but to check images again in the capturing order after scanning more than a hundred twenty thousand images. Therefore, a method of displaying images in specific organs with firstly considering the examinee's medical history and of showing images memorized as important images for a disease diagnosis regardless of the capturing order has been required so as to facilitate and simplify the diagnosis through scanning and examining images in a body lumen.

Also, the data size of about hundred twenty thousand images captured by an in-vivo imaging device 30 is 4 GB to 12 GB size, and thus it is required for at least 5 min to 10 min to download the images from a server 250 under 1:1 server-client system, and it is required in multiple users environment for much more than tens of minutes to download images from a server due to a data transmission bottleneck problem.

Therefore, doctors who diagnoses diseases by examining the images have no choice but to waste time for waiting for the download. Also, doctors affected by time limit hastened the diagnosis thereby causing an inaccurate diagnosis.

### DETAILED DESCRIPTION OF THE INVENTION

### Objects of the Invention

These disadvantages of the prior art are overcome by the present invention. It is an object of the present invention to provide a method of arranging images as a space configuration on a map view having plural rows and plural columns instead of time-dependently arranging images thereby enabling to recognize at a glance what disease is suspected, and of classifying images into subgroups in which the images are systematically and spatially organized thereby realizing exactly and promptly diagnose.

That is, it is the object of the present invention to provide a method of displaying tens of thousands of images capturing digestive organs on at least one map view, whereby a user may freely examine the images regardless of the order of capturing and check the symptoms of disease within a short time considering the examinee's medical history.

First of all, it is the object of the present invention to provide a method of creating a new sub-map view by dividing, separating or copying from existing map views, thereby increasing the efficiency and convenience of diagnosis using the sub-map view.

The other object of the present invention is to provide a method of easily finding disease symptom by presenting handled images for images which are hardly noticeable by naked eyes owing to neighboring similar color near disease symptoms thereby finding even a slight disease symptom without mistake.

On the other hand, another object of the present invention is to provide a method to firstly receive and display characteristic images or interested images related to disease of examinee.

Thus, the object of the present invention is to enable fast and accurate diagnosis of examinees even during time of transferring image data

### BRIEF DESCRIPTION OF THE INVENTION

In order to attain the above mentioned object, the present invention provides a method of displaying images obtained from an in-vivo imaging device, which comprises: a step of receiving data of original images captured by an in-vivo imaging device in a body lumen; a step of creating simplified images from the original images, the simplified images having lower resolution than the original images; and a step of displaying at least one map view which has a plurality of columns and a plurality of rows, at least one part of the map view being filled with the plurality of the simplified images in rows and columns.

Herein, the terminology of ‘map view’ in this specification and claims is defined to show images in plural rows and plural columns and also includes a source map view which shows most images captured by a capsule endoscope as well as at least one sub-map view of which images are copied, separated or divided from the images of the source map view or of other sub-map view. Also, the terminology of ‘a simplified image’ is defined as an image of which the resolution is lower than an original image captured by a capsule endoscope.

According to one of the important characteristics of the present invention, the locations of the images on the map view are rearranged based on either a column or a row on the map view so as to maintain the previous location order of the images, when the number of the images on the map view is altered, that is, when the size of the images on the map view is altered. Thus, regardless of the alteration of the size or the number of images on a map view during the scan process, a user can scan images through the map views while enlarging or reducing the size or the number of images displayed on map views in the firstly arrayed order of the images (e.g., an order of capturing, an order of digestive organs).

The step of creating the simplified images is performed by creating at least a first set of simplified images and a second set of simplified images wherein the first set and the second set have different resolution each other; and then a set is selected from one set of the first set or the second set and the simplified images on the map view are displayed from the selected set. That is, after a plurality of sets of simplified images are created in advance, of which the resolutions are different from one another and are lower than the resolution of the original images, the simplified images of one set selected from the plurality of sets are displayed on the map view, and thus it is possible to display stepwise-altered sizes of simplified images on the map view in a predetermined rate within a short time.

Although a user may not manually advance images displayed on at least one map view, in order that a user can scan images displayed on a map view in succession, when the number or the size of images displayed on a map view is input (or set up), a suitable set of the plurality of sets of simplified images is selected, and a portion of all images to be displayed are displayed on the map view at a time, and then, the next portion of images to be displayed are displayed on the map view in a predetermined interval, and thus all images to be displayed are automatically displayed on map views in succession with the setup number (or size) of images. Therefore a user can scan and check lots of images on the whole within a short time.

Generally, as tens or hundreds of images are displayed on a map view, the size of images is small. Thus, the present invention provides a step of displaying as an enlarged view for images on the map view. The enlarged image may be selected by a movement of cursor, or may be sequentially displayed from a designated image like a video play. From this construction, a user may concentrate individual images together with scanning lots of images on a map view and may promptly and correctly examine if a disease may be suspected.

The present invention also includes a step of displaying a sequence bar which shows the order of all images to be displayed, and a step of marking the area on the sequence bar of which the area corresponds to locations of images on the map view, whereby a user can recognize where the images on the present map view displayed on a screen are located over the all images to be displayed or which area of the digestive organs the images on a screen correspond to.

Further, the present invention also includes a step of displaying a minimap bar which is formed of the combination of lots of the reduced size of the original images; and a step of marking the area on the minimap bar, of which the area corresponds to locations of images being displayed on the map view.

According to one of the most importing features of the present invention, a new sub-map view can be created from existing map views by selecting images from an existing map view or by combining at least one portion of images from existing map views. For example, the sub-map view may be a split map view created by being split from an existing map view, and/or the sub-map view may be a separated map view created by being separated from an existing map view, and/or the sub-map view may be an edited map view created by being copied from at least one existing map view, and/or the sub-map view may be an combined with at least one above sub-map view. The separated map view is distinguished from the edited map view in that the images separated from an existing map view are deleted in the existing map view while the images copied from an existing map view are not deleted in the existing map view. Herein, the sub-map view may be created from a source map view as well as other sub-map view.

Therefore, a user may create at least one new sub-map view based on diverse standards during scanning or examining images captured in a body lumen, instead of passively scanning images, the present invention enables a user to positively and spatially classify images based on at least one of disease kinds, colors organ areas, or other standards, and thus enables to a user to compare a disease suspected-images with one another or to compare captured disease suspected-images with representative disease images presented by medical institution, etc. Accordingly, a user may positively and correctly examine captured images without getting bored within a short time.

That is, although the conventional method requires a user to simply memorize or capture disease-suspected images before confirmation of diagnosis, as the present invention enables a user to make a summary map view by splitting, separating or copying disease suspected images during scanning process, it is possible to confirm a diagnosis based on more objective grounds with putting together all disease suspected images and then examining the suspected images on the whole in a map view. Further, in case that a disease may not correspond to a symptom as 1:1, the present invention provides a summary map view to collect disease-suspected images whereby a user can more correctly confirm a diagnosis based on the simultaneously examining lots of images distributed over diverse digestive organs

Also, although the conventional display processing method did not provide a form of the medical certificate until repeatedly scanning the captured images, as the present invention enables to present sub-map view collected by disease-suspected images, a user can save time to repeatedly examine the already-scanned images.

As the locations of images may be transferred in a map view, highly disease-suspected images may be moved forward to the front part of the map views while lowly disease-suspected images may be moved backward to the rear part of the map views, a user may conveniently classify map views and diagnose with efficiency.

Alternately, when an area covering at least two images on a map view is designated, the images in the area are displayed as a little bit enlarged images as thumbnail images, a user may check larger plural images at the same time via the thumbnail images.

The sub-map view may be created so as to display images divided by a time interval in accordance with a predetermined set up or a user's input. For example, if 80,000 images are captured by an in-vivo imager such as a capsule endoscope, and if a user wants to make 20 sub-map views, each sub-map view may be formed as displaying 4,000 images.

Also, the sub-map view may be created so as to display images divided by an arbitrary (e.g., inconstant) time interval. Further, each sub-map view may contain different number of images. For example, if 120,000 images are captured by an in-vivo imager, the sub-map view may be created by collecting images in each digestive organ such as stomach, small intestine or large intestine, or may be created by the number of images user's input such that 10 thousand images, 50 thousand images, 30 thousand images and 30 thousand images may be assigned to each of sub-map views. Therefore, a user may scan lots of captured images on map views in an arbitrary order as the user likes.

On the other hand, human vision system cannot exactly recognize a colored shape without concentration, of which the color is similar with the background color. Especially, the human vision system has color weakness for redish-green and bluwish-yellow. For example, redish colored disease cannot be easily recognized in detail for the greenish digestive fluid in the stomach, and greenish colored disease cannot be easily recognized in detail for the redish colored disease.

In order to solve the weakness of the human vision system, a color treatment may be performed for a unit of a sub-map view, and thus color weakness of human vision system may be assisted for realizing more accurate and correct disease findings. It is also secondary advantageous to reduce a user's vision tiredness in that a user may find minute disease findings with taking less concentration on it.

That is, a color treatment for a map view by adding, removing and altering specific colors and/or specific color filters and/or specific frequency filters or by changing color space, it is easier to find disease suspected symptoms from lots of images. The color treatment may be performed by at least one analysis in a HIS color space, HSL color space, HSV color space, YIQ color space, YCbCr color space, YUV color space, XYZ color space, CMY color space, Color wavelength space, opponent color space. And the color treatment may be performed by adding specific color filter or by changing into opponent colors.

The present invention also provides a method further comprising: a step of dividing the images into a plurality of subgroups; and a step of creating at least one representative image for each subgroup, wherein the representative images are arrayed on the map view in the step of displaying. For example, the step of dividing may be performed so that every image in a subgroup falls within a predetermined similarity. Therefore, only scanning of a map view of displaying the representative images for each subgroup, the whole characteristics of all captured images may be scanned.

Similarly the present invention provides a method further comprising: a step of analyzing the correspondences for at least one event over the original images; and a step of classifying the images having higher correspondences than the predetermined ones; wherein the classified images are displayed on a map view in the step of displaying, whereby an examiner may firstly check a suspected disease considering the examinee's medical history than other images.

On the other hand, the other embodiment of the present invention provides a method of displaying images obtained from an in-vivo imaging device, which comprises: a step of receiving data of original images captured by an in-vivo imaging device in a body lumen and forming an original image set; a step of creating at least one simplified image set, the simplified images in the simplified image set having lower resolutions than the original images in the original image set; a step of displaying images on a map view which has a plurality of columns and a plurality of rows, the images on the map view being selected from one of the original image set or the simplified image set.

That is, when captured images in a body lumen are received from an in-vivo imaging device, after creating a plurality of sets of simplified images of which the resolutions are lower than the resolution of the captured original images, one of the pre-created sets of simplified images is selected in accordance with a user's input, the simplified images corresponding to user's input size (or number or resolution) are displayed on a map view by calling the simplified images from the selected set within a short displaying time.

Herein, the sets of simplified images may be stored in a memory such as USB memory, hard disk, CD-ROM, DVD, etc and may be used for later diagnosis. The sets of simplified images may be more than two set having different resolutions.

Also, each set of simplified images and a set of original images are linked with one another through link information, and thus, the images on map views may be easily alternated by one of every set in accordance with the resolution or the size of images.

Most of all, one of the pre-created plural sets such as sets of simplified images and/or the set of original images is selected and displayed on the map view in accordance with the designated number of images (or the designated image size), and thus the number of images on a map view can be altered step by step as the images on the map view are chosen from one of the pre-created plural sets.

The present invention also provides an apparatus of displaying images obtained from an in-vivo imaging device, which comprises: an image receiver of receiving data of original images captured by an in-vivo imaging device in a body lumen; a processing unit of creating simplified images from the original images, the simplified images having lower resolutions than the original images; and a display unit of displaying at least one map view which has a plurality of columns and a plurality of rows, at least part of blanks on the map view being filled with the plurality of the simplified images in rows and columns.

On the other hand, the present invention provides a method of transferring and displaying images in server-client system, which comprises: a step of hierarchically classifying the images transferred to a server into more than two groups; a step of downloading images in the group from the server to a client in sequence of the hierarchy, and a step of displaying the images on screen of the client downloaded from the server during the step of downloading.

That is, different from the conventional method that captured images only can be displayed after finishing all image data from the server to the client and can be displayed in sequence of the capturing sequence, the present invention provides a method of firstly classifying images into plural groups, and then downloading images in groups in sequence of a user's preference, and displaying downloaded images even during downloading process from the server to the client, so that a user can check his or her interested images at the client prior to downloading all images from the server. Therefore, as a user does not need to wait for downloading all image data from the server, diagnosis can be promptly realized.

Also, the present invention provides an image transfer server comprising: a record storage medium of storing image data capturing a body lumen; a processing unit of hierarchically classifying based on the similarities with neighboring images or on the correspondences for at least one event; and an image transfer unit of transferring the images into the client in a hierarchical sequence. For example, if an image relates more closely to an event, the image is downloaded earlier from the server to the client and displayed on screen at the client.

The present invention also provides an image display client comprising: a storage medium of storing image data downloaded from a server, the image data being captured in a body lumen by in-vivo imaging device; a display unit of displaying images downloaded from the server as soon as the image data is downloaded; an input unit of designating the prior downloading area in which images is to be firstly downloaded than other images; and an image downloading unit of downloading from the server the images in the prior downloading area.

### ADVANTAGEOUS EFFECT

As described above, the present invention has an advantageous effect that instead of time-dependently scanning images for diagnosis one by one in capturing sequence, by arranging reduced form of images crowdedly as a space configuration on a map view having plural rows and plural columns whereby a user may spatially check disease suspected images by groups displayed on a map view regardless of time sequence.

Especially, when an examinee has a medical history in some digestive organs, the present invention has a merit that a user may directly move to the images of the interested digestive organ area by scrolling of the map view and then examine images in detail by enlarging the part of the interested area, whereby a user does not need to wait until images he wishes to examine are displayed.

Also, the present invention enables to create new sub-map views from existing map views and to move the sub-map view to any place in a unit of sub-map view regardless of capturing sequences, whereby a user can positively scan and be concentrated on examining tens of thousands of images without getting bored and can systematically classify images into groups based on suspected disease or digestive organ area, etc.

The present invention has another advantageous effect that a user can easily find minute disease symptoms from lots of images by a color treatment for necessary map views thereby supplementing the color weakness of human vision system.

Meanwhile, the present invention has a merit of firstly downloading images in sequence of a user's preference and displaying downloaded images soon, so that a user can examine his or her interested images for diagnosis at the client before all images are downloaded from the server.

Also, as images are displayed in map view as soon as the images having user priority are downloaded from a server, it is possible to check at a glance the locations of images where were downloaded just before, and to promptly examine by enlarging images in a specific area if there is disease symptom.

Further, the present invention has another effect that, when an prior downloading area is designated by a user even during a download from a server to a client, as the images in the designated interest area are firstly downloaded than any other images whereby a user does not need to endure his curiosity for disease symptoms and thus enhance the diagnosis efficiency.

Also, the present invention enables to show the quantitative result of correspondences to events on map views and/or to firstly download images which satisfy the quantitative correspondences thereby promptly examining specific disease symptoms prior to other possible disease symptoms.

### EMBODIMENTS

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 shows schematic diagram of showing that image data captured in body lumen by an in-vivo imaging device is transferred from a receiver to a processing apparatus.

FIG. 2 is a block diagram of an apparatus of displaying images obtained from an in-vivo imaging device in accordance with one embodiment of the present invention.

FIG. 3 depicts a flowchart of a method of displaying images in accordance with one embodiment of the present invention.

FIGS. 4 to 7 are representation of images displayed on screen according to method in FIG. 3

FIG. 8 depicts a flowchart of a method of displaying images in accordance with other embodiment of the present invention.

FIG. 9 is a representation of images displayed on screen according to method in FIG. 8.

FIGS. 10 and 11 are representations of images with annotations in accordance with other embodiment of the present invention.

FIG. 12 is a representation of images with enlarged thumbnail images in accordance with other embodiment of the present invention.

FIGS. 13 to 16 are representations of images for creating sub-map view in accordance with other embodiment of the present invention.

FIGS. 17 to 19 are representations of images of arranging sub-map views on screen in accordance with other embodiment of the present invention.

FIGS. 20 and 21 are representations of images showing summary map view in accordance with other embodiment of the present invention.

FIGS. 22 to 24 are representations of images with color treatment in accordance with other embodiment of the present invention.

FIG. 25 shows schematic diagram of showing that image data captured in body lumen by an in-vivo imaging device is stored in a server, and then the image data is downloaded to a client.

FIG. 26 depicts a flowchart of a method of transferring image data and displaying images in accordance with other embodiment of the present invention.

FIG. 27 is a block diagram of a server in FIG. 26.

FIG. 28 is a block diagram of a client in FIG. 26.

FIG. 29 shows a schematic diagram showing the concept of hierarchical transfer.

FIG. 30 is a representation on screen when the images of a first group in FIG. 26 are transferred from the server to the client.

FIG. 31 is a representation on screen when the images of a second group in FIG. 26 are transferred from the server to the client.

FIG. 32 is a representation on screen when the images of a third group in FIG. 26 are transferred from the server to the client.

FIG. 33 is a representation on screen when the rest of images in FIG. 26 are transferred from the server to the client.

FIGS. 34 and 35 are a representation having an interested area designated by a user.

FIGS. 36 to 39 are representation on screen while receiving image data of the interested area from the server.

FIG. 40 depicts a flowchart of a method of displaying images in the server-client system in accordance with other embodiment of the present invention

FIG. 41 shows a schematic diagram of color treated map view

FIGS. 42 to 44 are photographes of map views having different number of images thereon.

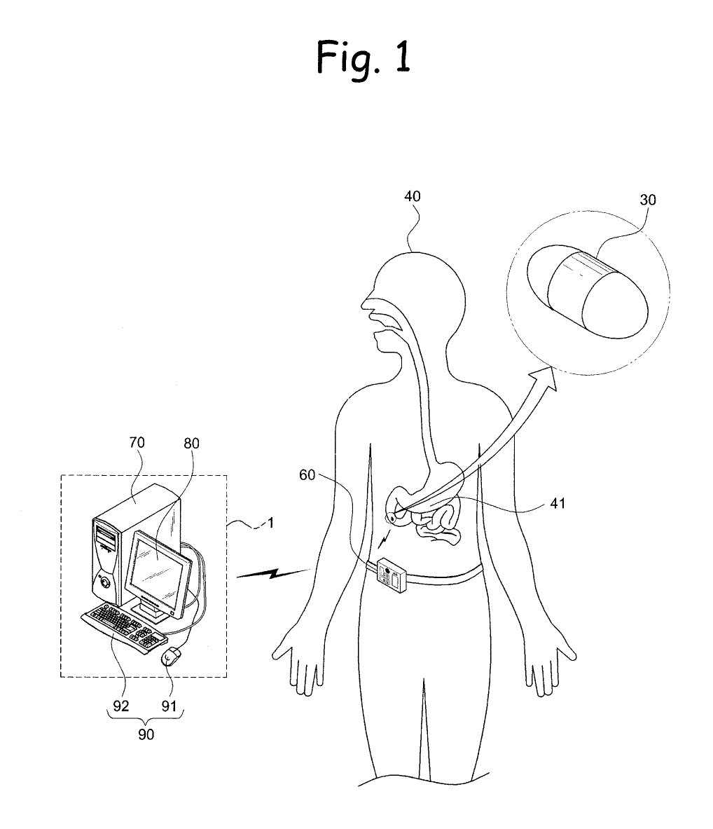

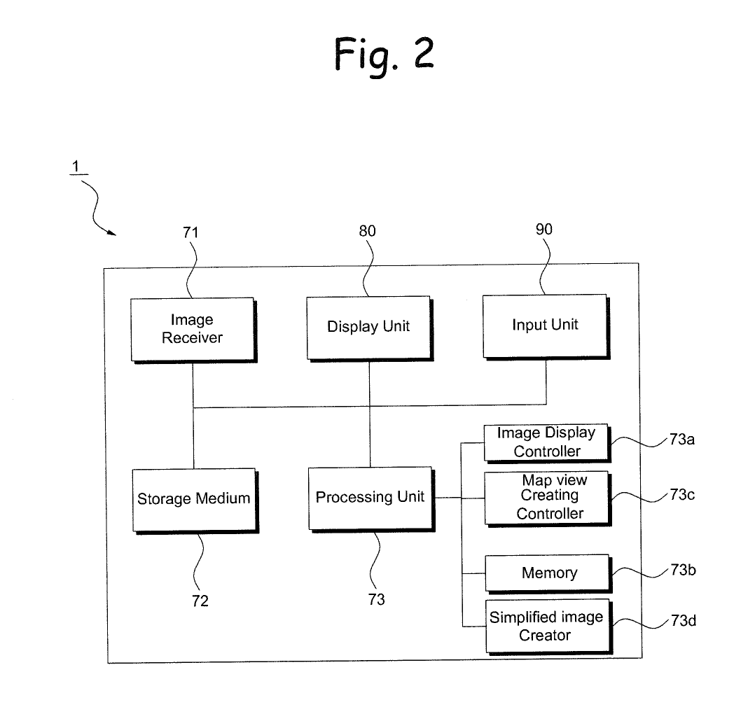

### DETAILED DESCRIPTION OF PREFERRED EMBODIMENTS

The foregoing and other objects, features, aspects and advantages of the present invention will become more apparent from the following detailed description of the present invention when taken in conjunction with the accompanying drawings.

In describing the present invention, detailed description of laid-out function or structure is omitted in order to clarify the gist of the present invention.

As shown in the Figures, an apparatus 1 of displaying images obtained by an in-vivo imaging device 30, which comprises: an image receiver 71 of receiving data of original images from an in-vivo imaging device 30 via a receiver 60 to the apparatus 1, a storage medium 72 such as a hard disk of storing image data, a display unit 80 of displaying images stored in the storage medium 72 in the form of a map view 110, an input unit 90 for inputting user's instructions and orders such as a mouse 91 and a keyboard 91, a processing unit 73 of creating simplified images of which the resolutions are lower than the resolution of the original images and of creating sub-map views 110a-110i by splitting, copying or separating existing map view 110 and then of moving the sub-map views 110a-110i as a user likes.

The processing unit 73 includes an image display controller 73a of controlling to display images captured by the in-vivo imaging device, a map view creating controller 73b of creating sub-map views 110a-110i by splitting, copying or separating existing map view 110 and of moving the sub-map views 110a-110i, a memory 73c to memorize and to execute a user's input order, and a simplified image creator 73d of creating new simplified images having lower resolutions from the original images captured by the in-vivo imaging device.

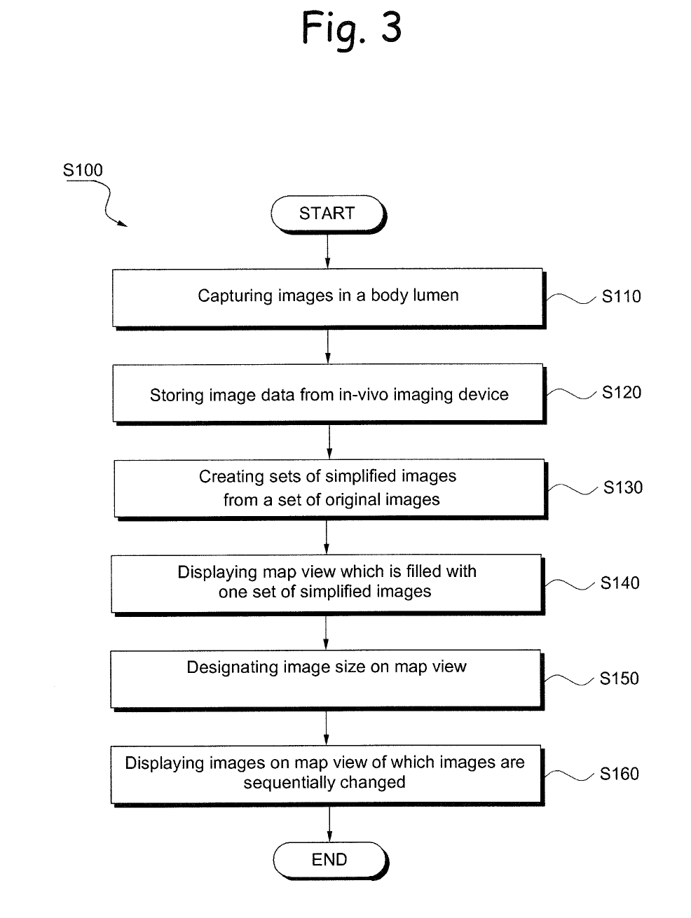

As illustrated in FIG. 3, a method S100 of displaying images obtained from an in-vivo imaging device of one embodiment in accordance with the present invention is realized as follows. Firstly, an in-vivo imaging device 30 captures images in a body lumen (S110). Then, the image data captured by the in-vivo imaging device 30 is transferred to the image receiver 71 by wire communication or wireless communication via the receiver 60 and then stored in the storage unit 72 (S120).

Next, after an original image set is created by all the images received by the image receiver 71 or created by the portion of all the captured images by excluding unnecessary images such as blackish images, at least one set of simplified images are created from the original image set. As the simplified images are created to be displayed in a reduced shape, the resolutions of the simplified images are lower than that of the original images step by step (S130).

Herein, although it would also be allowable to create one set of simplified images, it is more desirable to create plural sets of simplified images so as to display diverse sized reduced images. Each of the plural sets of simplified images has a different resolution with one another. For example, the sets of simplified images may include a first set of simplified images having 70% resolution of the set of the original images, a second set of simplified images having 50% resolution of the set of the original images, a third set of simplified images having 20% resolution of the set of the original images, and a fourth set of simplified images having 3% resolution of the set of the original images. The resolution of one set of simplified images is all the same. Also, the original images corresponds to each set of simplified images as 1:1.

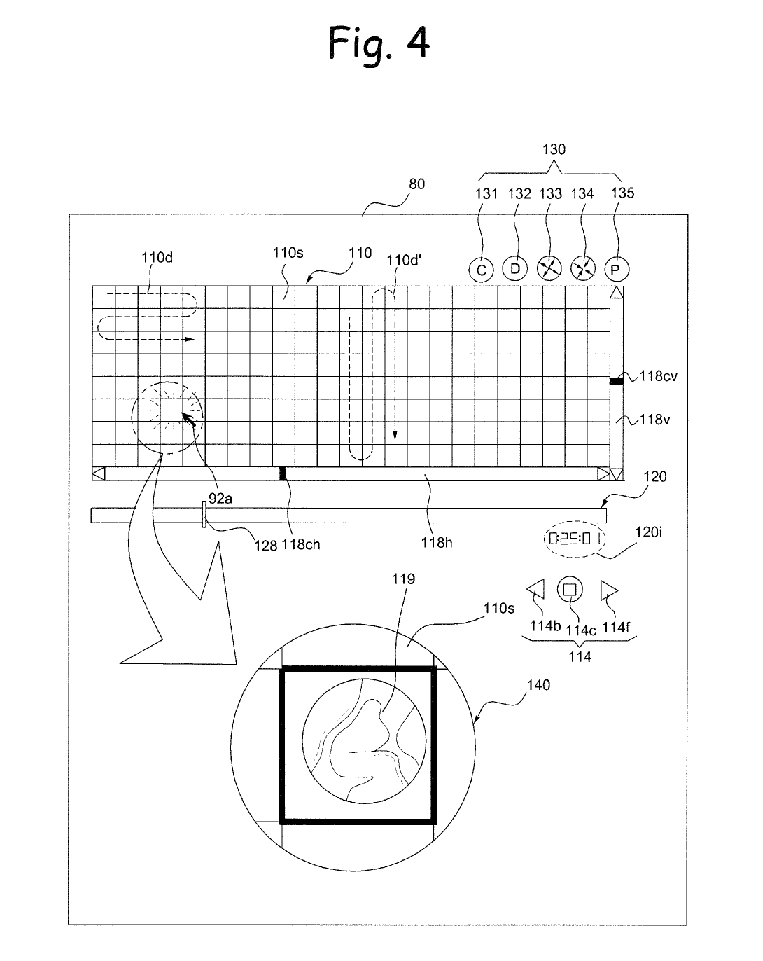

Then, as illustrated in FIG. 4, simplified images from one set of simplified images are displayed on the form of map view which has plural columns and plural rows (S140). Herein, as indicated by numeral 110d or 110d′, the blanks 110s of the map view in plural rows and plural columns are filled in a predetermined sequence by images as reduced shapes. All the images may be shown on a map view, while only a portion of images may be shown on a map view.

The first map view 110 displayed on screen at first may display all the original images captured in a body lumen, or may display some of original images excluding unnecessary images for a diagnosis. Also, the total shape of the first map view 110 may be displayed on screen while the only portion of the first map view may be displayed on screen. Hereinafter, the first map view displaying all the images or most images only excluding unnecessary images is referred to be as ‘source map view’.

In case that the only portion of the first map view may be displayed on screen, the other portion thereof may be displayed by scrolling using scroll keys 118ch, 118cv. Thus, a user directly look for images in which the user is interested in view of an examinee's medical history.

Mostly, as the first map view 110 tends to display as many as images thereon, it is desirable to call and display the lowest simplified images (e.g., a fourth set of simplified images) on the first map view. Also, a map view may display reduced sized images to fill the blanks 110s simply by reducing the size of the original images captured by in-vivo imaging device. In order to reduce the displaying time, it is more effective to call and display the simplified images having lower resolution created from the original images.

Therefore, as the map view 110 displays lots of images in plural rows and in plural columns, a user may spatially scan lots of reduced size of images at a glance and easily notice a colorful disease symptom such as bleeding before scrutinizing each of images one by one.

Although the number of the original images captured in body lumen reaches 120,000, the map view 110 in FIG. 4 is drawn as a simplified form of having less number of columns and rows for easy understanding.

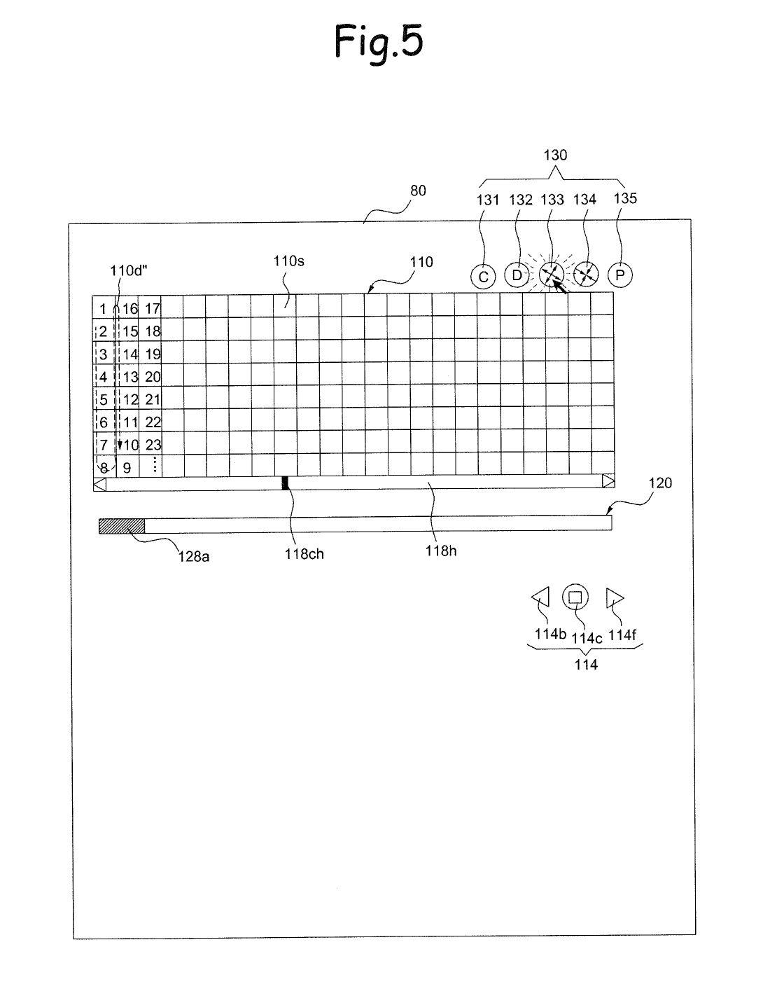

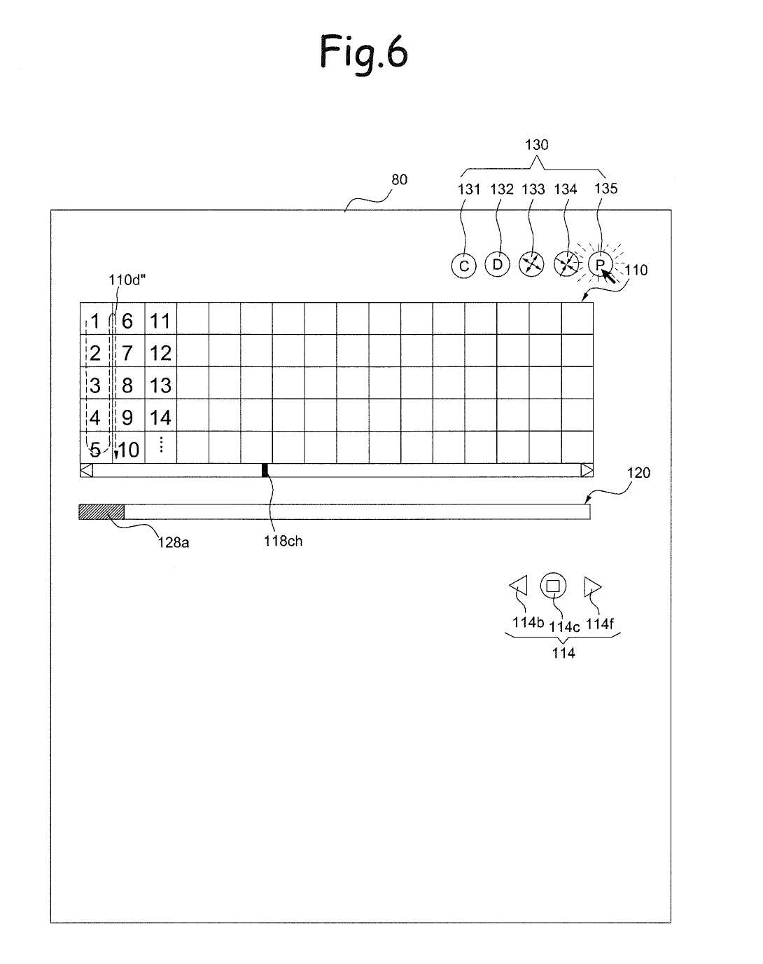

Then, a user decides and designate the size of images displayed on map views (S150). As illustrated in FIG. 5, several operating keys 130, 114 are indicated on screen near the map view 110. A user may control the size of images on a map view by clicking enlargement button 133 thereby enlarging the size of images step by step as shown in FIG. 6. In other words, the number of images displayed on a map view is lowered. To the contrary, when a user may click the reduction button 134, the size of images on a map view becomes smaller step by step.

Herein, if a map view is simply enlarged, the surroundings of the map view before the enlargement disappears when the map view becomes enlarged. Therefore, a simple enlargement cannot make a user scan all images efficiently. Similarly, if a map view is simply reduced, the surrounding images which the user already scanned on the map view appear again on the enlarged map view. Therefore, a simple reduction also makes a user feel inconvenient and inefficient for scanning images on a map view. In order to solve these problems, when the number of the simplified imaged on the map view is altered, the locations of the simplified images on the map view are rearranged based on either a column or a row on the map view so as to maintain the previous location order of the simplified images.

A rearrangement based on a column on a map view is given as an example. The map view 110 in FIG. 5 displays images arrayed along vertical direction as the sequence of numeral 110d′. That is, the first column of the map view 110 displays 8 images (image number 1, 2, 3, . . . , 8) from the top to the bottom in sequence, and similarly the second column of the map view 110 also displays 8 images (image number 9, 10, . . . , 16) from the top to the bottom in sequence. At this time, when a user clicked the enlargement button 133, the enlarged map view 110 displays only 5 images from the top in sequence as shown in FIG. 6. Herein, if the first two columns shows image number 1, 2, 3, 4, 5 and 9, 10, 11, 12, 13, the images at the surroundings (i.e., image number 6, 7, 8 . . . ) should be scanned by scrolling the enlarged map view thereby causing a user to feel time-consuming and irritated.

Therefore, the locations of the images on the map view are rearranged based on a column so as to maintain the previous location order of the images, when the number of images on the map view is altered. Concretely, when the map view is enlarged as showing 5 images in a column from showing 8 images in a column, the first row in the second column starts with image number 6 instead of image number 9 as shown in FIG. 6, whereby a user can scan all the images displayed on the previous map view without scrolling the enlarged map view. In case that the number of images on a map view is reduced, the same principle is applied.

In case that the size of images on a map view is enlarged by clicking the enlargement button 133, the images on the map view is called from the first set of simplified images of which the resolution is closer to the resolution of the set of original images. Similarly, in case that the size of images on a map view is reduced by clicking the reduction button 134, the images on the map view is called from the third set of simplified images of which the resolution is farther from that of the set of original images. Like this way, the size of images on a map view is step by step altered.

One set of simplified images may match one predetermined size rate of image size. However, according to other embodiment, one set of simplified images may match more than two predetermined sizes by adjusting a little bit the size of one set of simplified images. However, as the original images is large in data size, in view of shortening the displaying time on a map view, it is not desirable to show the original images on a map view just by reducing its size.

The set of original images, the first set of simplified images, the second is set of simplified images, the third set of simplified images, etc. are created and stored so that all the simplified images of all sets having different resolutions and the original image are serially linked with one another. That is, one specific configuration of one original image is copied into plural simplified images having different resolutions and they are all serially linked with one another. Therefore, when a cursor 92a is located for enlarging a specific image on the map view 110 as illustrated in FIG. 4, the original image linked to the simplified image where the cursor 92a is located on the map view 110 is called and then displayed on the enlarged window 140 substantially in real time. Similarly, in alteration of image size on the map view as illustrated in FIG. 5 and FIG. 6, the link information is used. For example, an original image data #2041 for a specific configuration is serially linked to the first simplified image data #2041, the second simplified image #2041, the third simplified image #2041 and the n^{th} simplified image #2041 for the specific configuration. Therefore, whenever the size of a map view 110 is changed, the processing unit 73 calls the simplified image having suitable resolution and displays it within a short time. Herein, in addition that each of the original images are linked with each of the simplified images in every set, annotations such as a bookmark, label, tap, thumbnail image may be linked to each of the original images, whereby a user can more conveniently and efficiently scan disease symptoms.

Below the map view 110, at least one bar 120 including a timeline, a sequence bar or a minimap bar is indicated. Also, the area marking for the area where images being displayed on the map view is indicated on the bar 120. The sequence bar shows the order of all images to be displayed regardless of capturing order, while the minimap bar is formed of the combination of lots of the reduced size of the original images. Thus, if a user inputs annotations such as bookmark, thumbnail at some positions on the bar 120, the locations of the annotations on the timeline and the location of the annotations on the sequence bar may be differently located with one another.

Also, in case that the present setup condition (e.g., the number of images on a map view or the interval to advance the next map view) is fixed, total expected playing time 120i is indicated at the right below part of the bar 120 whereby a user can easily recognize the total expected playing time in accordance with user's input condition.

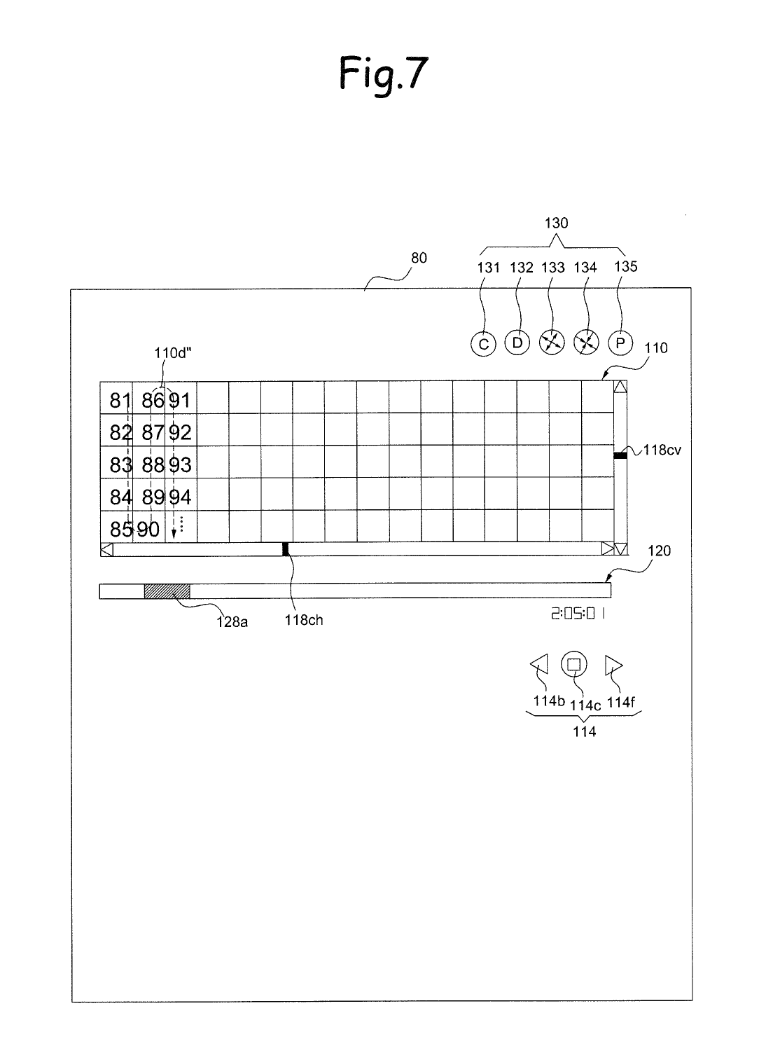

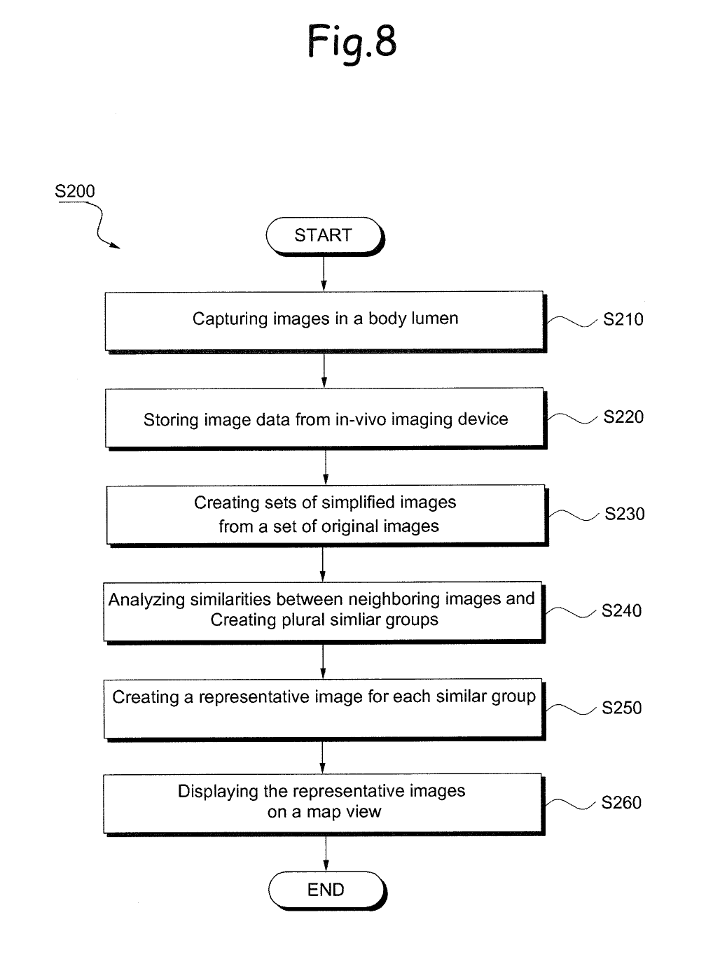

When the size of images on the map view 110 is designated in S140, a user presses one of playing buttons 135, 114f thereby displaying designated number of images on a map view for every predetermined interval (S150). For example, after the map view 110 in FIG. 6 displays eighty images (i.e., image number 1 to 80) at one time for a predetermined interval such as five seconds, the next map view 110 in FIG. 7 displays the next eighty images (i.e., image number 81 to 160) at a time for the same period, and then the next map view displays the next eighty images (i.e., image number 161 to 240) sequentially. In this process, an examiner can scan lot of images on the whole if there are disease-suspected images. Also, when interested images are found during the advance of the map view, the examiner may stop or reverse the process of advancing map views by using a stop button 114c or a reverse button 114b and may examine in detail.

According to another embodiment of the present invention, the present invention provides a method S200 of displaying images for reducing the scanning time of images. Generally, as an in-vivo imaging device 30 such as a capsule endoscope moves by peristalsis in a body lumen, when the in-vivo imaging device 30 moves slowly or stays for a long time at one position, a lot of similar images are captured. Thus, it is not efficient for an examiner to scan all images including lots of similar images. Therefore, the other embodiment in accordance with the present invention provides a method S200 comprising a step S210 of capturing original images in a body lumen 41 by an in-vivo imaging device 30, a step S220 of storing data of images in a storing medium 72, and a step S230 of creating plural sets of simplified images having lower resolutions than the resolution of the original images. Herein, as described above, the sets of simplified images are serially linked to the set of original images so as to be alternately displayed with one another.

Then, a similarity analysis is performed by quantitatively comparing images with neighboring images in terms of configuration, color, etc. Through the similarity analysis neighboring similar images are included in one similar subgroup (S240). The similarities between images and previously neighboring images are obtained as quantitative values and also normalized. Thus, the similarity between two images having same configuration due to temporary stop of an in-vivo imaging device 30 will be obtained as 100. Quantitative similarities for twenty images as an example may be indicated as follows.

TABLE 1

| Image No | Similarity |
|---|---|
| Image #1 | 0.0 |
| Image #2 | 7.0 |
| Image #3 | 80.1 |
| Image #4 | 79.2 |
| Image #5 | 99.7 |
| Image #6 | 98.5 |
| Image #7 | 92.2 |
| Image #8 | 80.4 |
| Image #9 | 50.2 |
| Image #10 | 50.3 |
| Image #11 | 20.9 |
| Image #12 | 78.5 |
| Image #13 | 88.2 |
| Image #14 | 92.3 |
| Image #15 | 94.6 |
| Image #16 | 99.5 |
| Image #17 | 97.6 |
| Image #18 | 92.4 |
| Image #19 | 48.6 |
| Image #20 | 56.7 |

According to the above table 1, as the image #1 is the first image capturing a body lumen and thus cannot be compared with the previous image, the similarity of the image #1 is 0.0. The similarity value 7.0 of the image #2 means that the image #2 is similar with the previous image #1 by 7%, and the similarity value 99.7 of the image #5 means that the image #5 is similar with the previous image #4 by 99.7%. As a low similarity value means a rapid scene change while a high similarity value means a slow scene change. When the images of low similarities are displayed on a map view, the map view results in displaying the summary of characteristic images for a diagnosis because the configuration of the images on the map view differ with one another more than an examiner designates. Accordingly, an examiner can scan the characteristic images selected based on a predetermined similarity criterion thereby enabling to diagnose efficiently and promptly. That is, the characteristic images selected based on a predetermined similarity criterion can be a summary of characteristic images for diagnosis.

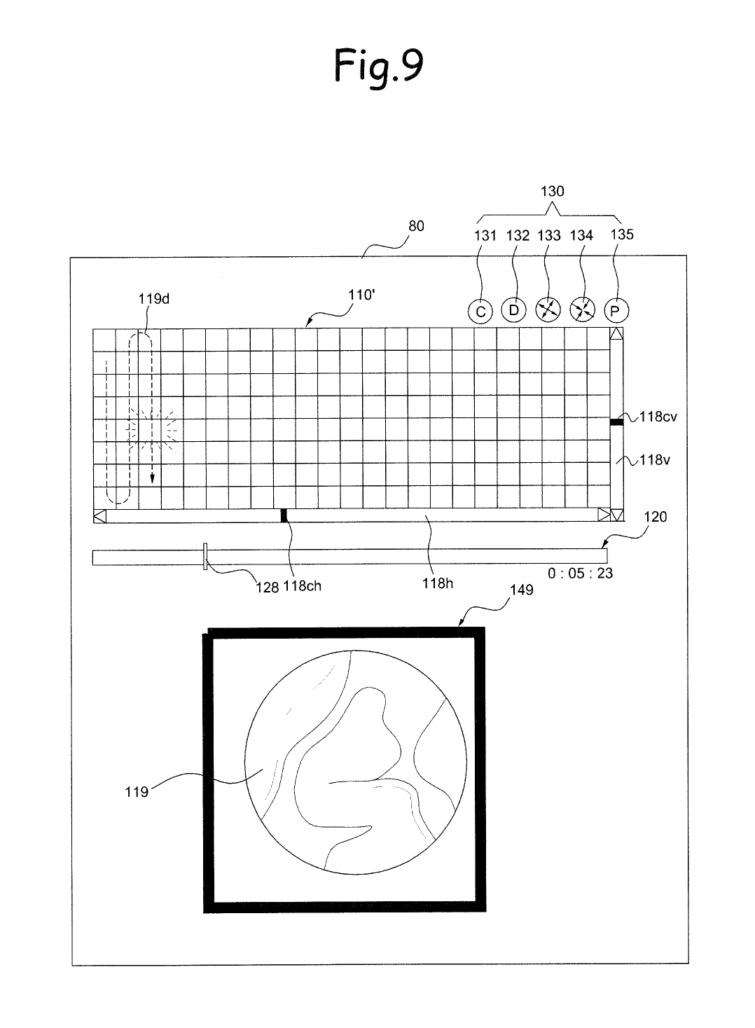

Alternately, based on the quantitative similarity analysis, the images capturing a body may be grouped into plural similar subgroups. In this case, as the images in each of the similar subgroups are similar with one another, a representative image is created from each of the similar subgroups such as selecting one image for each similar subgroup, or merging an image from plural images in a similar subgroup, or creating a new image by taking characteristics of the images in a similar subgroup using conventional various methods (S250). Therefore, if the only representative images for each similar subgroup are displayed on at least one map view 110′ in FIG. 9, as the map view 110′ displays all images necessary to diagnose by removing unnecessary images, it can be done within a short time and on the whole to scan all images required for a diagnosis. Herein, in order to scan all the images on the map view 110′ in detail, the images 119 on the map view 110′ can be played in the enlarged window 149 along the array sequence 119d. It is desired to play the images on the map view 110′ with the original images having highest resolution in the enlarged window 149.

From the above method of the present invention, it can be possible for an examinee to easily obtain an image summary where all images required for a diagnosis are collected thereby enhancing the diagnosis efficiency and reducing the diagnosis time.

According the another embodiment of the present invention, a method is provided as comprising a step of analyzing the correspondences for at least one event over the original images; and a step of classifying the images having higher correspondences than the predetermined ones; wherein the classified images are displayed on a map view in the step of displaying, whereby a user can select images related to specific more than one disease symptom in view of an examinee's medical history and then make the selected images displayed on a map view and can check in advance if the disease may be improved or newly found.

That is, the map view may collect images which highly correspond to ‘events’ which an examiner designated. And the map view may be a sub-map view or a source map view. In other words, by obtaining quantitative correspondences of the images capturing a body lumen for the designated at least one event, the only images having close correspondences for the event can be classified and displayed on the map view. Therefore, especially in case of recognizing the examinee's medical history, it is much helpful to check within a short time whether the previous disease has progressed or not.

Herein, the terminology of the ‘event’ may be one of disease symptoms or disease such as bleeding, ulcer, polyp, cancer, tumor and may be the specific region of digestive organs. However, the above examples do not restrict the range of the event of the present invention. Also, the terminology of ‘disease symptom’ in this specification or in the claims includes a meaning of ‘something wrong with examinee's body as a sign of illness’, ‘a disease itself or a illness itself’, and all signs worth remembering during a diagnosis which is not directly related to disease. Also, the terminology of ‘disease symptom’ includes all findings related to something necessary for a diagnosis such as food, foreign bodies. Therefore, it is desirable to designate more than two events so as to obtain total information relating to disease symptoms by the event analysis.

The terminology of ‘correspondence’ or any related terms in this specification or in the claims includes a meaning of ‘proximity value how an image is close to an event’. Herein, the correspondence may be expressed as a normalized index.

For example, in case that an examiner examines twenty images capturing by an in-vivo imaging device so as to check an improvement of examinee's previous bleeding in a small intestine, the examiner will be interested in images in small intestine for checking the previous bleeding symptom. Thus, although all images obtained over examinee's digestive organs may be analyzed for obtaining quantitative correspondences for diverse events such as bleeding, polyp, ulcer, when the examiner designate ‘bleeding’ as an event, a sub-map view is created and displayed on screen by collecting images which have high correspondences for the bleeding event. Accordingly, an examiner (usually a doctor) does not need to scan tens of thousands of images one by one, and directly check the improvement of the examinee's previous bleeding symptom.

The analysis of quantitatively obtaining correspondences of images for events may be performed by diverse methods. The method may be one of or combination of more than two of spectrum analysis, motion flow analysis, shape analysis, wavelet analysis, frequency analysis. As each digestive organ performs different type of peristalsis, the analysis may be performed by recording a continuous peristalsis of digestive organs and recognizing the contraction pattern of digestive organs. For example, characteristic shape can be copied from images captured by an in-vivo imaging device 30 based on energy into frequency domain, and then, the boundary of events can be sensed by a function of High Frequency Content which characterizes the contraction of digestive organs whereby the correspondences for events can be obtained.

Also, the quantitative correspondences for events may be analyzed by comparing images captured by an in-vivo imaging device 30 with a representative disease symptom image. In case of a bleeding event, as a red portion rises when digestive organs bleeds, the possibility of bleeding rises when the red portion of images rises over a predetermined portion. Generally, considering that a color of an image is formed by the combination of red, green and blue, as ratio of a specific color is similar with each other, the images are regarded as having close correspondences. For example, as the color information of an image may be converted into a color index by a frequency transformation based on luminance, when a quantitative color index of a first image is close to that of a second image, the first image can be regarded as close correspondence with the second image thereby analyzing images whether to have a high correspondence for each event.

As mentioned before, the event may mean the division of each digestive organ. In this case, the division location of the digestive organs such as a boundary of esophagus, stomach, duodenum, small intestine and large intestine may be sensed by transforming the images in a body lumen into the color index based on the luminance, and by finding the region where the color index is rapidly changed. Thus, as the event includes area divisions of each digestive organ. In case that more than two events including the specific digestive organ together with at least one specific disease symptom are designated by an examiner, it is possible for the examiner to directly scan the images satisfying the designated events (that is, specific disease symptoms in the specific organ).

At least one annotation may be input for each of the simplified images on map views. Herein, the annotation includes comments input as text, audio or video by a user, data or information measured by an in-vivo imaging device 30, and bookmark, label, tap, marker having function of searching the related linked images.

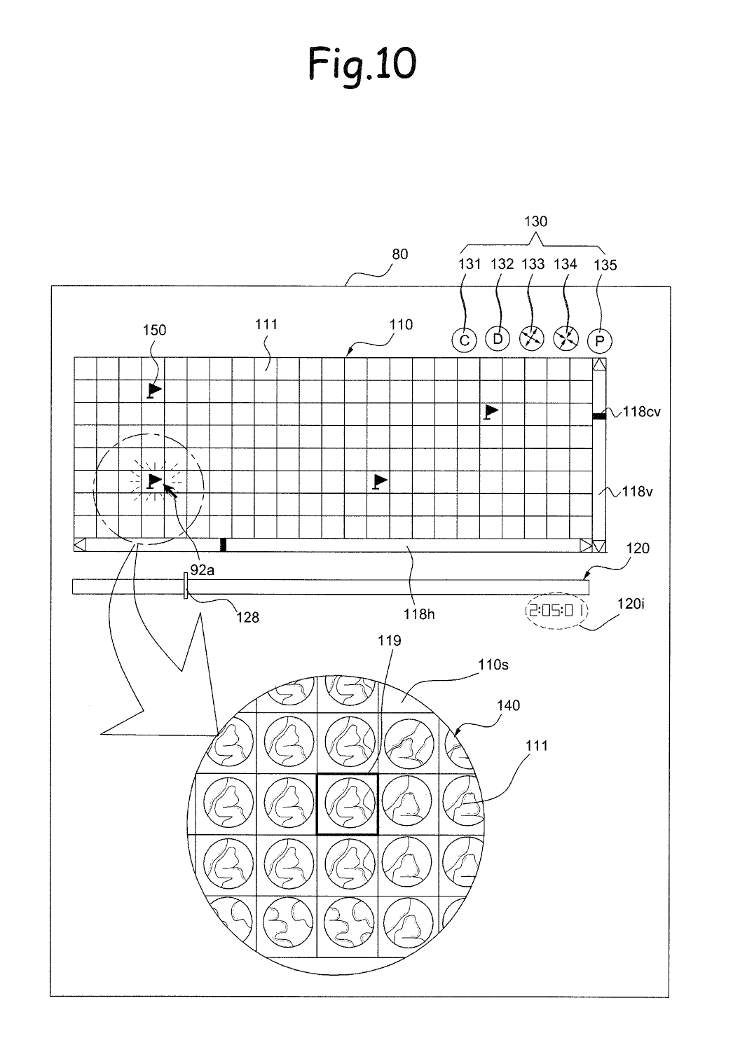

On the other hand, in case that disease symptom images are found while scanning images captured by an in-vivo imaging device 30, as shown in FIG. 10, a user may input flag-shaped bookmarks 150 as annotations on map view 110 by selecting ‘designation’ button on a popup window shown up by pressing right button of mouse 91. As it is difficult to recognize the detailed image from the reduced size of images 111 on the map view 110, it is useful to input the annotation 150 on the map view 110 for remembering specific images after viewing the enlarged images via the enlargement window 140, whereby a user can easily grasp on the whole where disease suspected images are found. The flag-shaped bookmark 150 may be other shape such as thick outline, ‘v’ shape, etc.

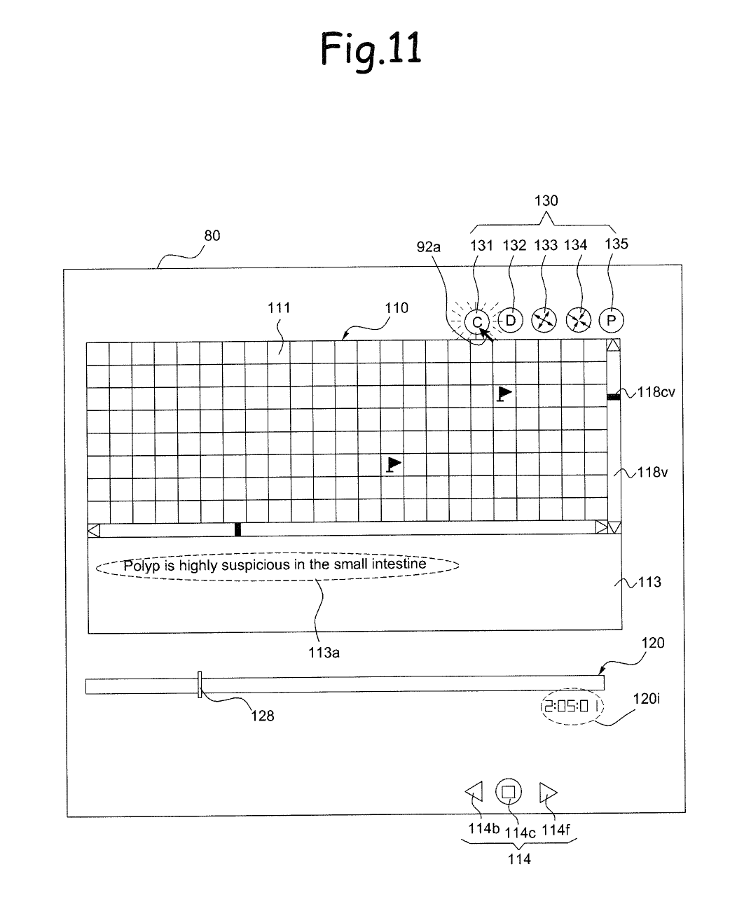

As illustrated in FIG. 11, a user can input comments 113a on a specific map view 110 by clicking a comment button 131 using mouse 92 and inputting any comments in a comment space 113 using keyboards 91. The comments 113a may relate to disease symptom, similarity, event correspondences for each image or for each map view.

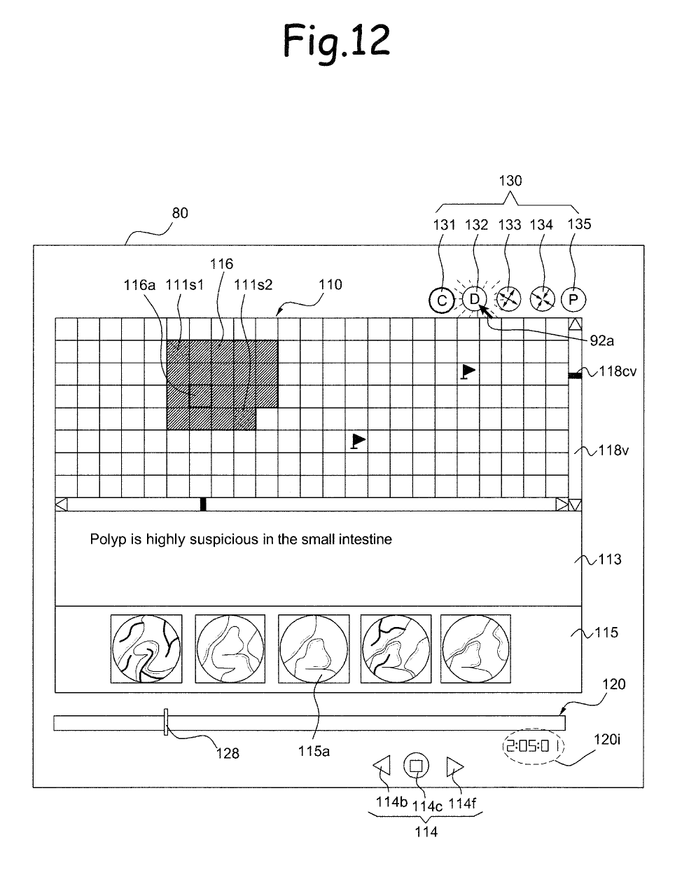

As illustrated in FIG. 12, when a user wishes to examine in detail for an area, the user may designate the area 116 by clicking twice on two images 111s1, 111s2 which are located in a boundary of the area 116 and then may click the area display button 132 thereby making the images in the designated area 116 play in the playing window 115 as thumbnail enlarged images 115a together with neighboring images. Herein, the progress of the enlarged images 115a may be controlled by the control buttons 114a, 114b, 114c; 114. Alternately, the enlarged image 115a may be solely displayed as a more enlarged view.

According to another embodiment of the present invention, map views are newly created as sub-map view 110a-110i . . . from existing map views 110 such as by splitting, separating or copying the portion of the existing map views. Herein, a map view which an examiner wishes to find based on a location or time is easily found by moving and double-clicking the control bar 128 on the time bar 120.

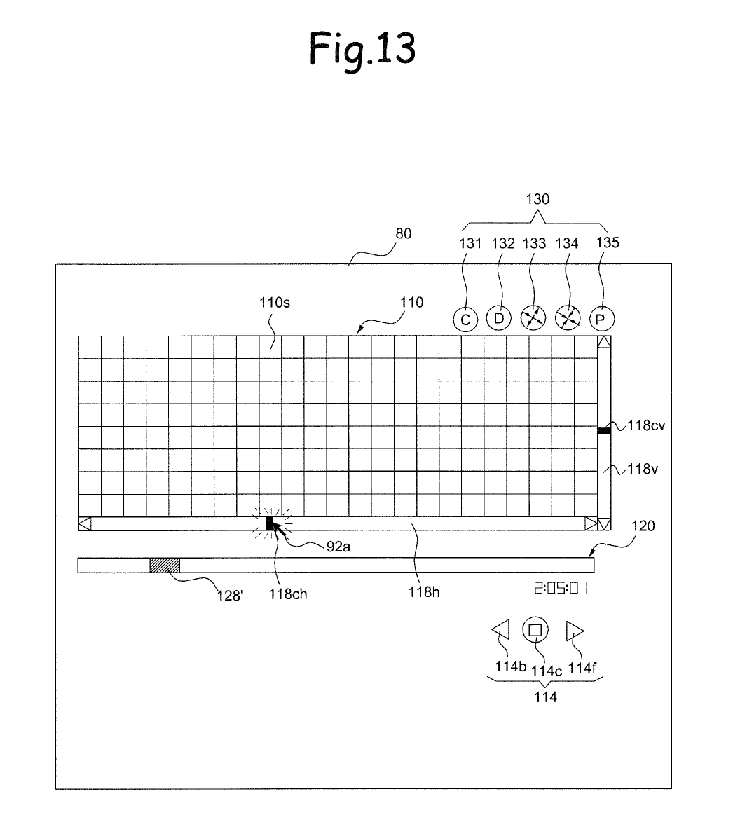

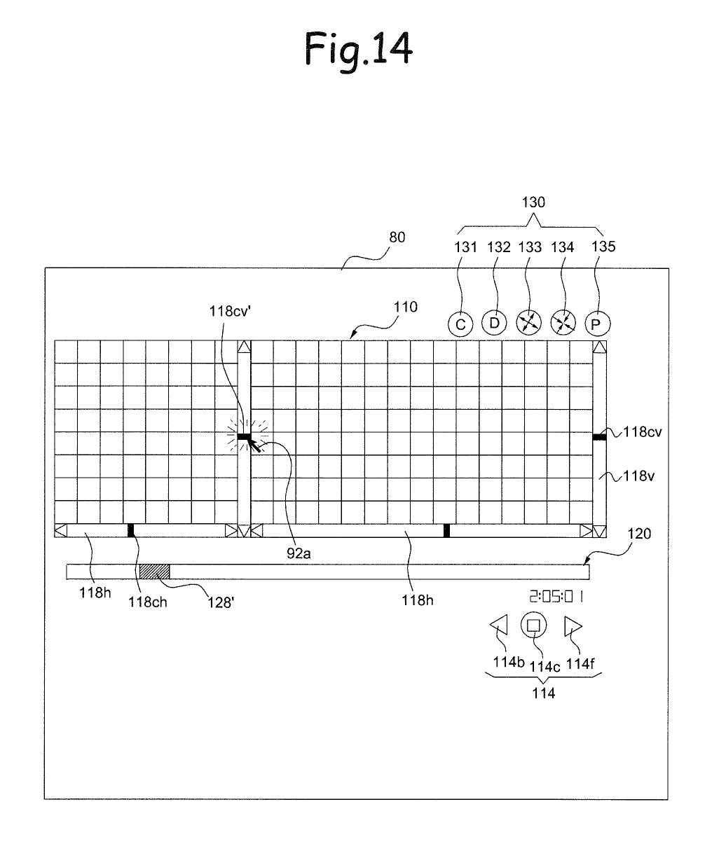

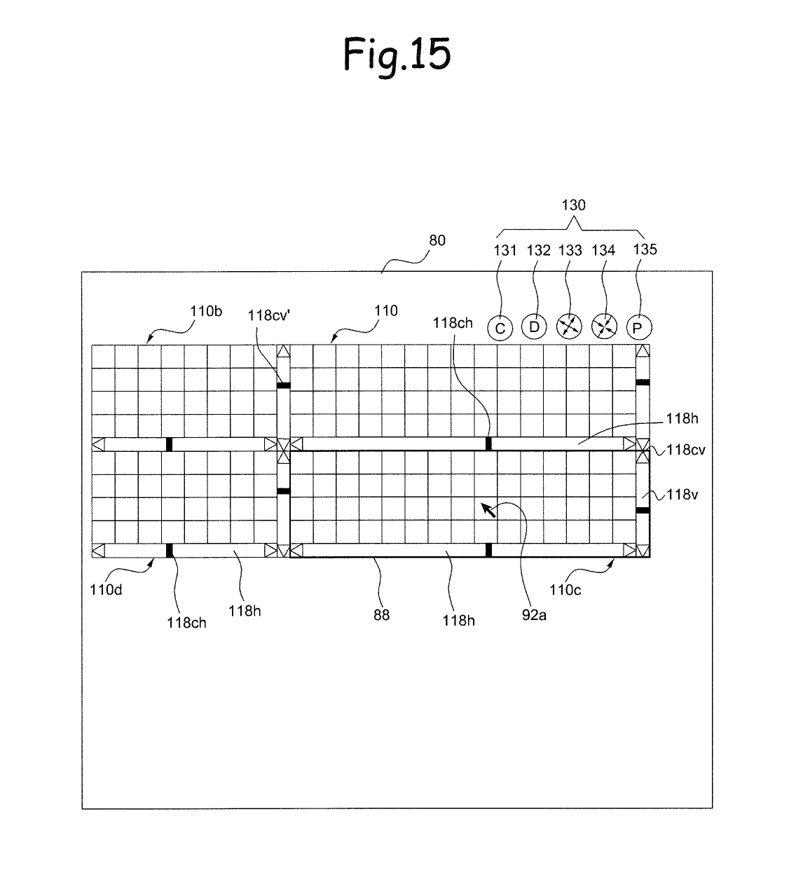

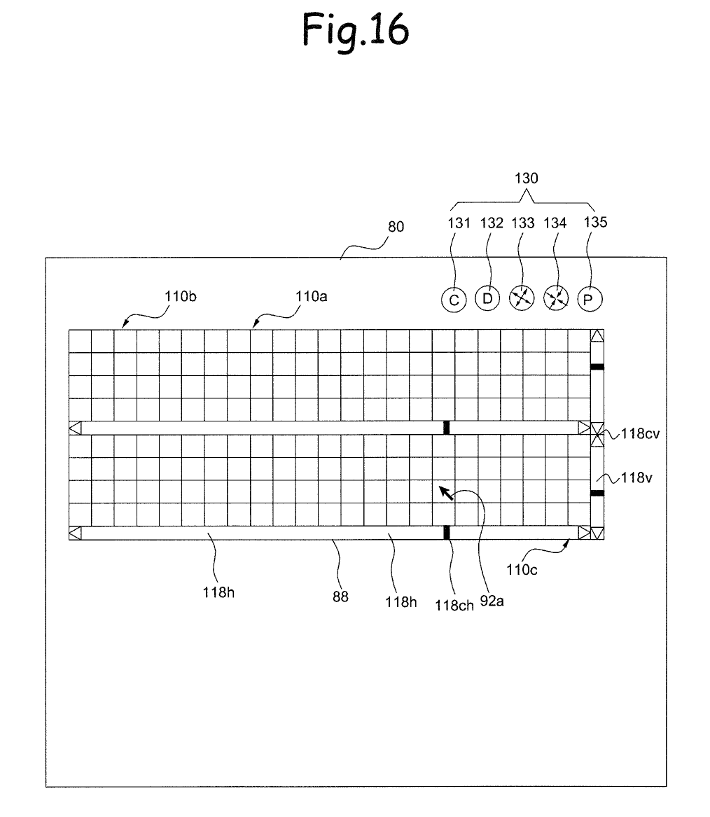

Concretely, as illustrated in FIG. 13, split bars 118ch, 118cv moves along the horizontal axis 118h and the vertical axis 118v in accordance with the drag of the mouse cursor 92a. Herein, by locating the mouse cursor 92a on the split bar 118ch at the horizontal axis 118h and by selecting ‘split item’ on a popup window shown up by clicking right button of the mouse 92, as illustrated in FIG. 14, the map view 110 is split horizontally into two sub-map views. Similarly, by locating the mouse cursor 92a on the split bar 118cv at the vertical axis 118v in FIG. 12 and by selecting ‘split item’ on a popup window shown up by clicking right button of the mouse 92, as illustrated in FIG. 16, the map view 110 is split vertically into two sub-map views. Also, by locating the mouse cursor 92a on the split bar 118cv at the vertical axis 118v in FIG. 14 and by selecting ‘split item’ on a popup window shown up by clicking right button of the mouse 92, as illustrated in FIG. 15, a map view 110 is additionally split vertically into four sub-map views.

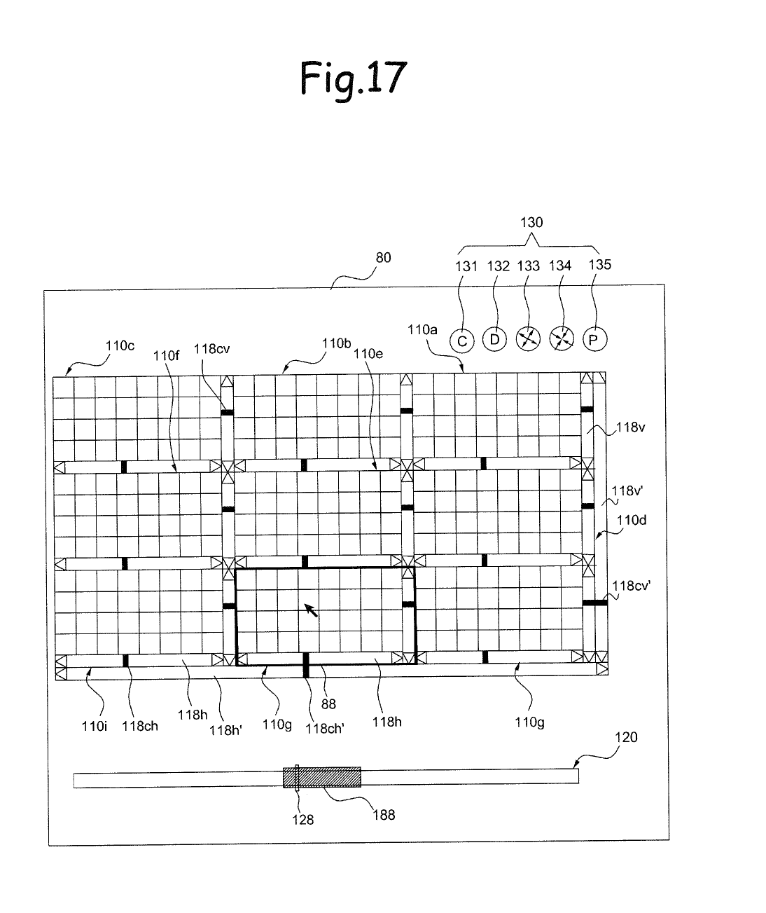

As illustrated in FIG. 17, when a map view 110 is split into plural sub-map views (i.e., split map view), as the thick outline 88 is activated on the map view when a mouse cursor 92a is located and double-clicked for a sign of designation of a map view, it can be possible to input annotations such as bookmark or comments in a unit of sub-map view. Also, the area of the images in the sub-map view 110g activated by the thick outline 88 is indicated as a region 188 on the bar 120, and thus a user can easily recognize where the images displayed on the designated sub-map view are located. Therefore, although a user may change the locations of sub-map views many times as the user likes, the user will not lose the locations of images on each of specific sub-map views thereby enhancing the efficiency and convenience of diagnosis.

The sub-map views illustrated in FIGS. 17 to 19 may display images which are collected in sequence of capturing a body lumen for a constant interval. Also, the sub-map views illustrated in FIGS. 17 to 19 may display images which are collected as having high correspondences over the predetermined criterion for each event including the area of the digestive organs. Further, the sub-map views illustrated in FIGS. 17 to 19 may display images which a user designated for memorize as characteristic ones during scanning map views.

Instead of splitting a map view 110, a new sub-map view 110a-110i . . . can be created by separating or copying the portion from at least one existing map view including the source map view and the other sub-map views. That is, as illustrated in FIG. 12, by designating the portion of images as an area 116 on a existing map view, and by selecting ‘create sub-map view by copy’ on a popup window shown up by clicking right button of the mouse 92, all the images of the existing map view displays the same images while the images in the designated area are also displayed in a newly-created sub-map view (i.e., editing map view). Similarly, by designating the portion of images as an area 116 on a existing map view, and by selecting ‘create sub-map view by separation’ on a popup window shown up by clicking right button of the mouse 92, the images in the designated area on the existing map are deleted while the images in the designated area are displayed in a newly-created sub-map view (i.e., separation map view).

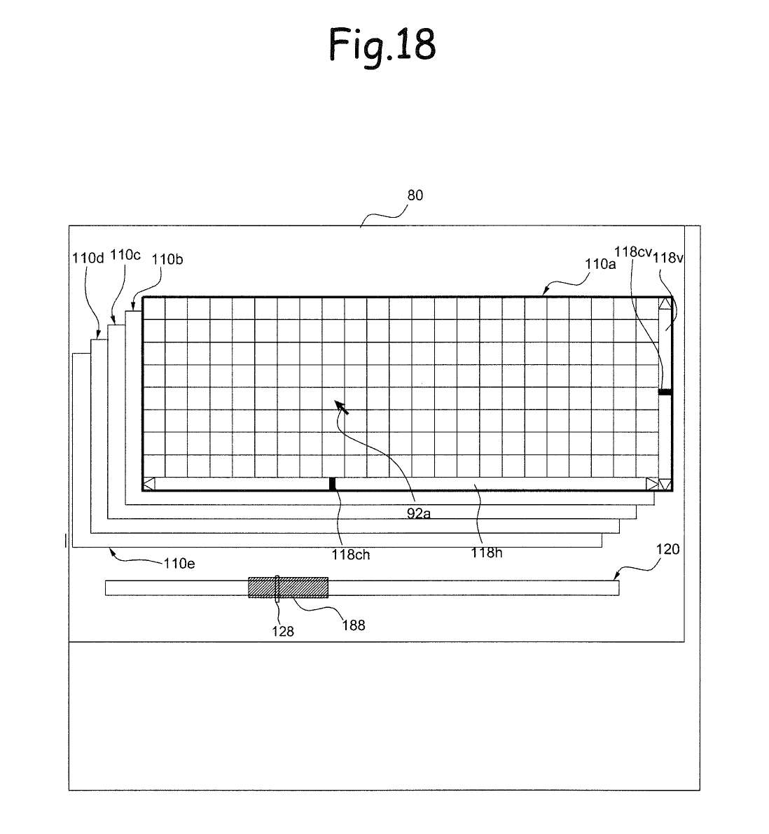

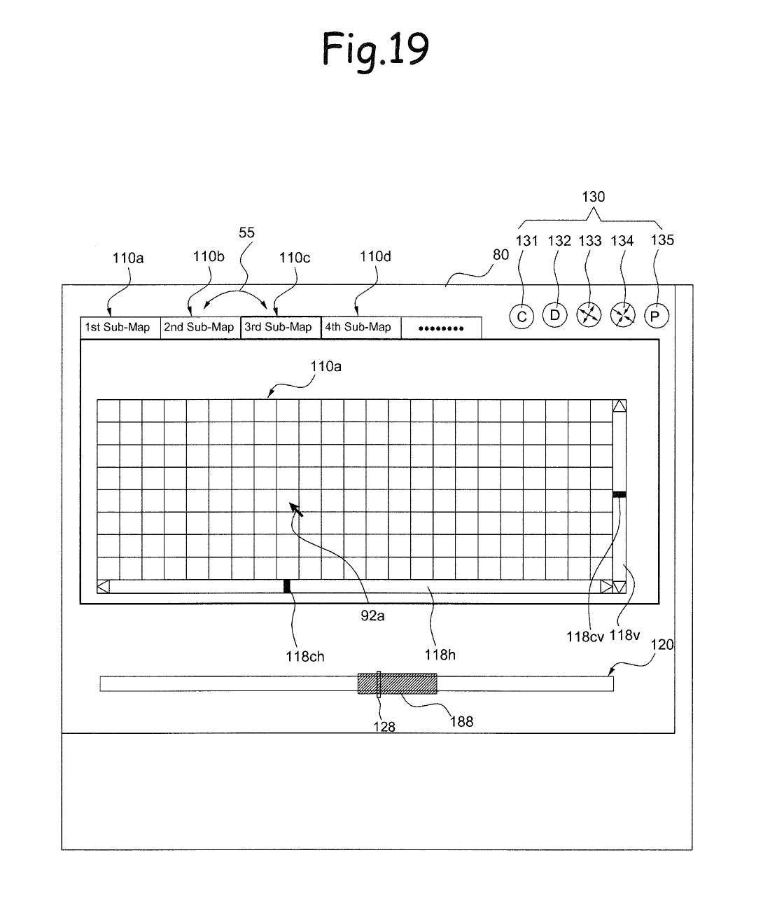

The sub-map views 110a-110i . . . may be arranged in various forms. The plurality of sub-map views 110a-110i . . . can be laid out in a board arrangement as illustrated in FIG. 17 or in a cascade arrangement as illustrated in FIG. 18 or in a tap arrangement as illustrated in FIG. 19.

In case that a plurality of sub-map views 110a-110i . . . are laid out in a board arrangement as illustrated in FIG. 17, an integrated horizontal axis 118h′ over the total horizontal axis and an integrated vertical axis 118v′ over the total vertical axis may be created on screen, and a user may split plural sub-map views at the same time using the horizontal split bar 118ch′ on the integrated horizontal axis 118h′ and the vertical split bar 118cv′ on the an integrated vertical axis 118v′.

A location of a sub-map view may be moved as an examiner likes by designating to activate the sub-map view and then by dragging the activated sub-map view by mouse into any place. As the location of each sub-map view is freely movable as a examiner likes, map views displaying images which are much related to a diagnosis are operated to move forwards while other map views displaying images which are less related to a diagnosis are operated to move backwards, and thus, the examiner can finally reduce the sub-map views relating to diseases step by step.

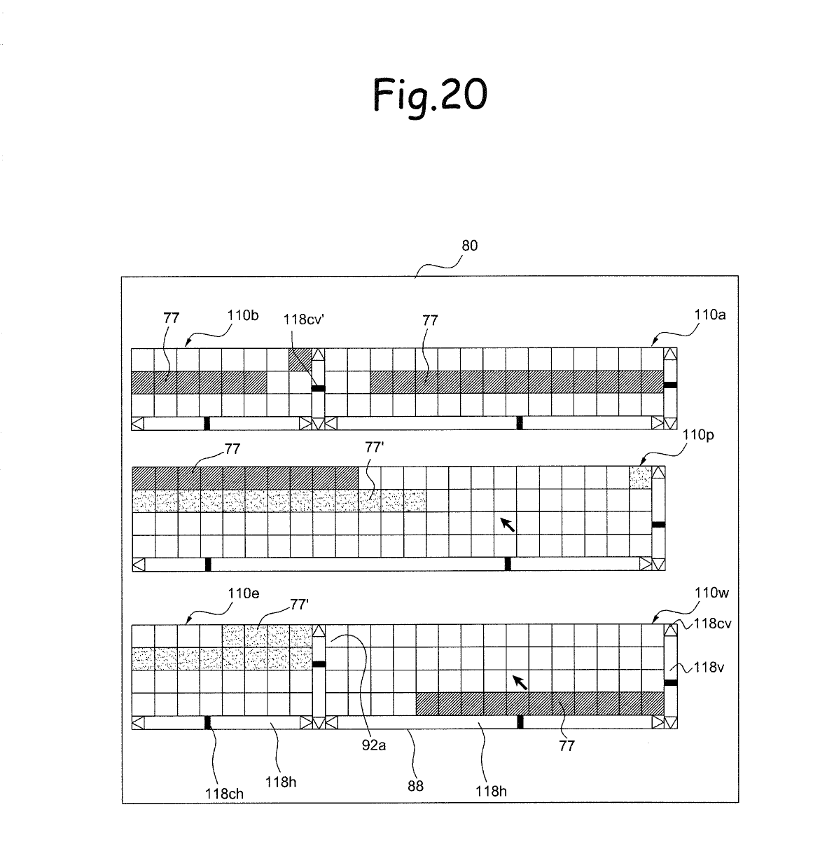

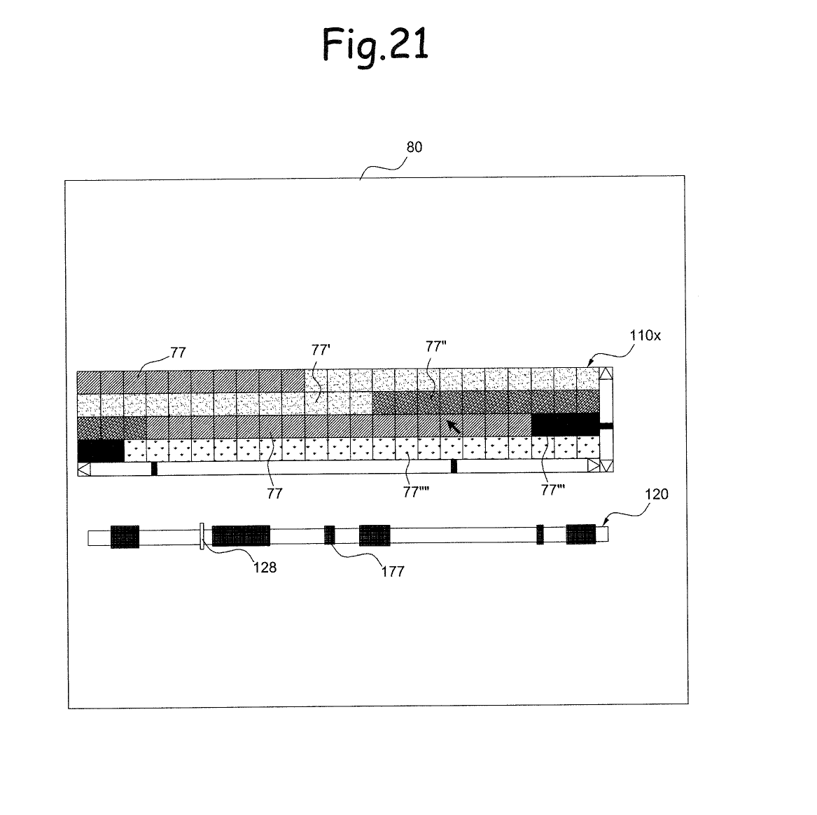

As a result, an examiner may finally diagnose an examinee's diseases while looking after the summary screen as FIG. 20 which shows disease-suspected images 77, 77′ on the classified map views 110a, 110p, 110w. Therefore, the final diagnosis can be done with reviewing all organs and all disease-suspected images at the same time thereby enhancing the accuracy of the diagnosis and convenience of examiners.

Further, all the disease-suspected images 77, 77, 77″, 77″′, 77″″ may be collected into a summary map view 110x. It is desired that the summary map view 110x is an editing map view by copying images from existing map views 110, 110a-110i . . . . Each location 177 of the disease-suspected images 77, 77, 77″, 77″′, 77″″ is indicated on the bar 120, an examiner easily notice where the disease-suspected images 77, 77, 77″, 77″′, 77″″ are located. From the summary map view 110x, a comprehensive diagnosis can be realized.

On the other hand, the human vision system cannot easily recognize a colored shape of which the color is similar with the background color. Therefore, by adding, removing or altering specific color for each digestive organ on sub-map views 110a-110i . . . , disease-suspected symptoms can be easily found with low concentration of the examiner.

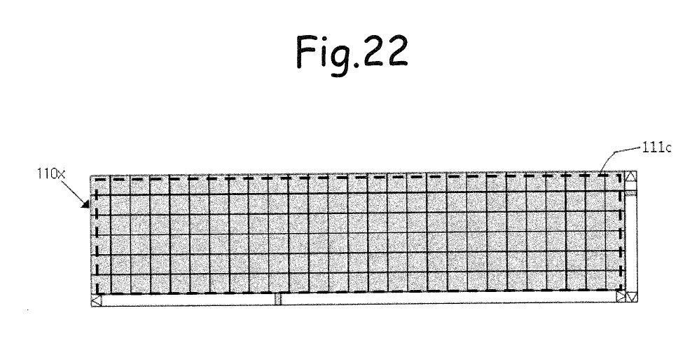

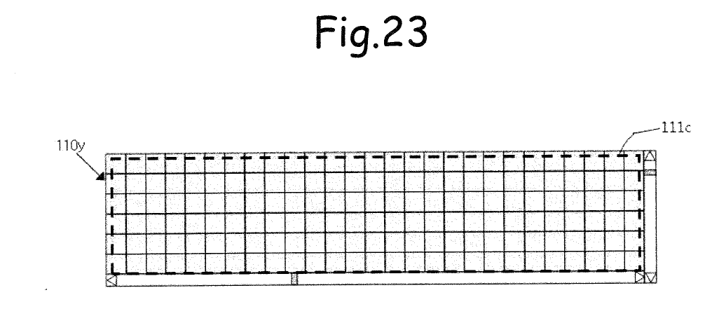

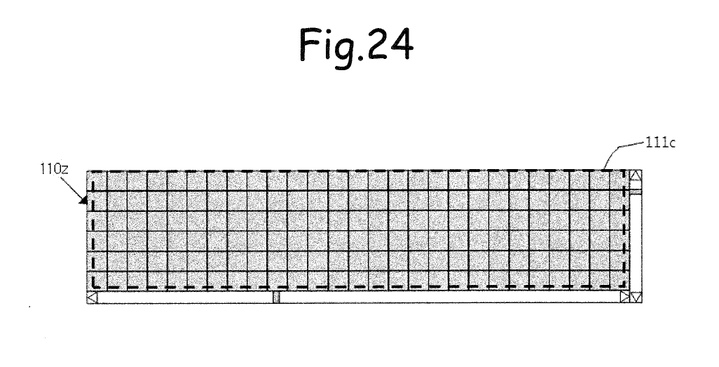

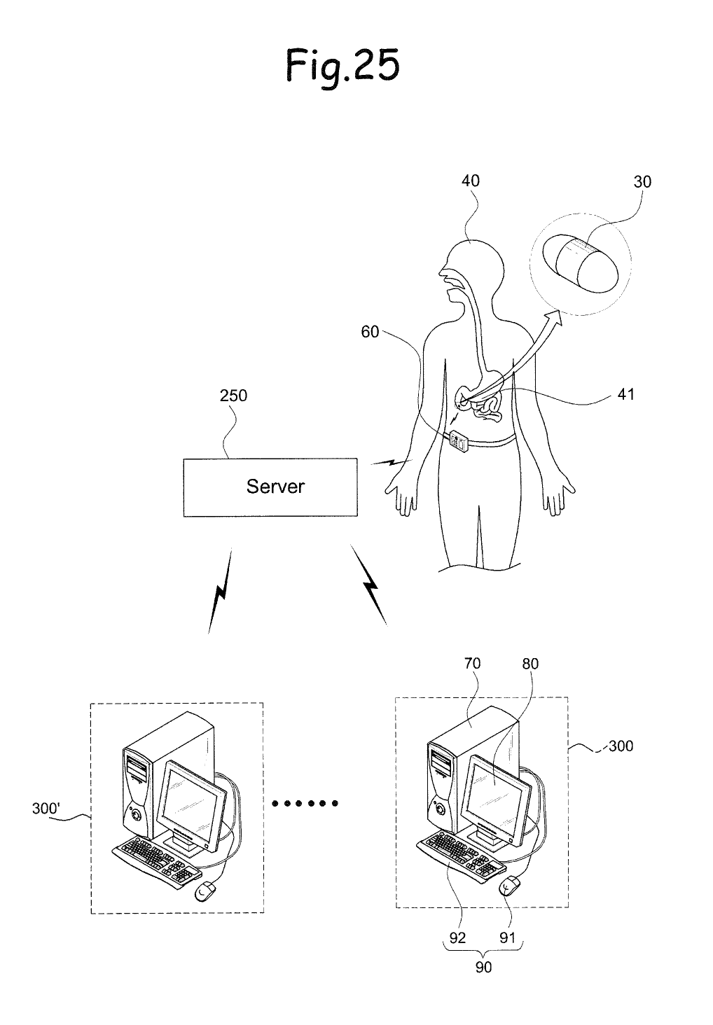

As illustrated in FIGS. 22 to 24, the above color treatment can be realized by putting on specific color such as red, green or blue to all the area 111c of a map view or to a portion of a map view. Besides, the color treatment of map views can be realized by using at least one of HIS (hierarchical information space) color space which makes divide information space hierarchically, YUV color space expressing the intensity of lights by luminance signal Y and color signal, CMK color space consisting of Cyan, Magenta, Yellow and dark black Key, YIQ color space controlling luminance and quadrature phase, YCbCr color space of controlling Y transferring black-white signal and Cb, Cr signal, RGB color space, XYZ color space, Color wavelength treatment, Opponent color space, a filter of filtering a specific color and a adder of adding a specific color.

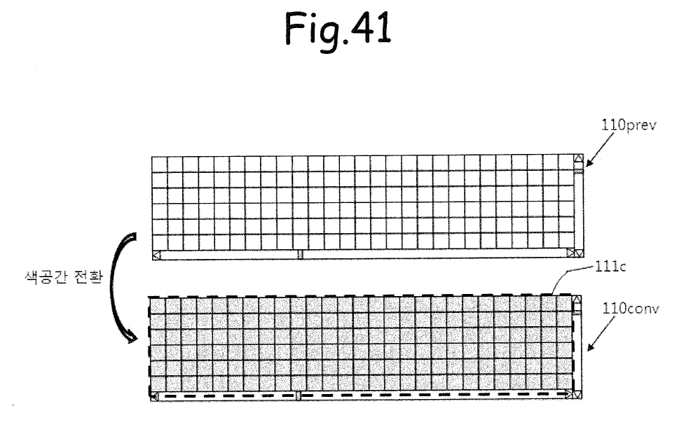

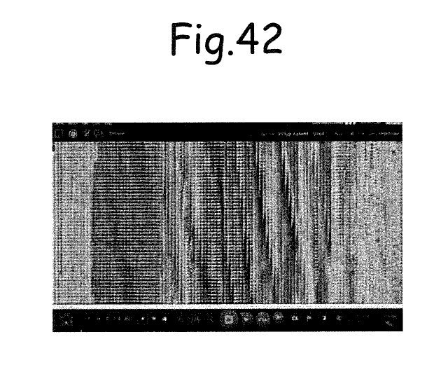

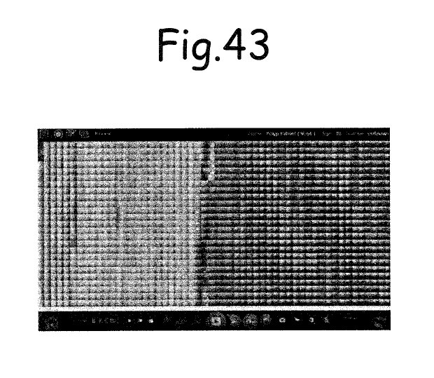

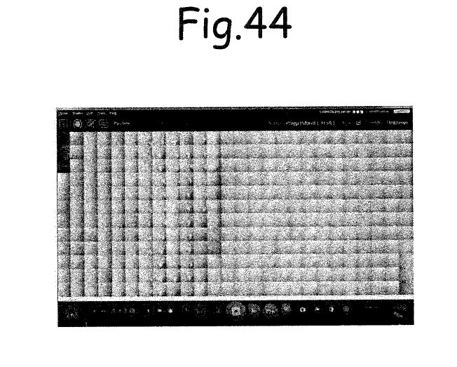

As illustrated in FIG. 41, the color treatment can be performed on the designated area 110c on sub-map views 110x, 110y, 110z so that the weakness of the human vision system especially on redish-green and bluwish-yellow can be supplemented, and thus an examiner can find a minute disease findings and disease symptoms with low visional concentration.

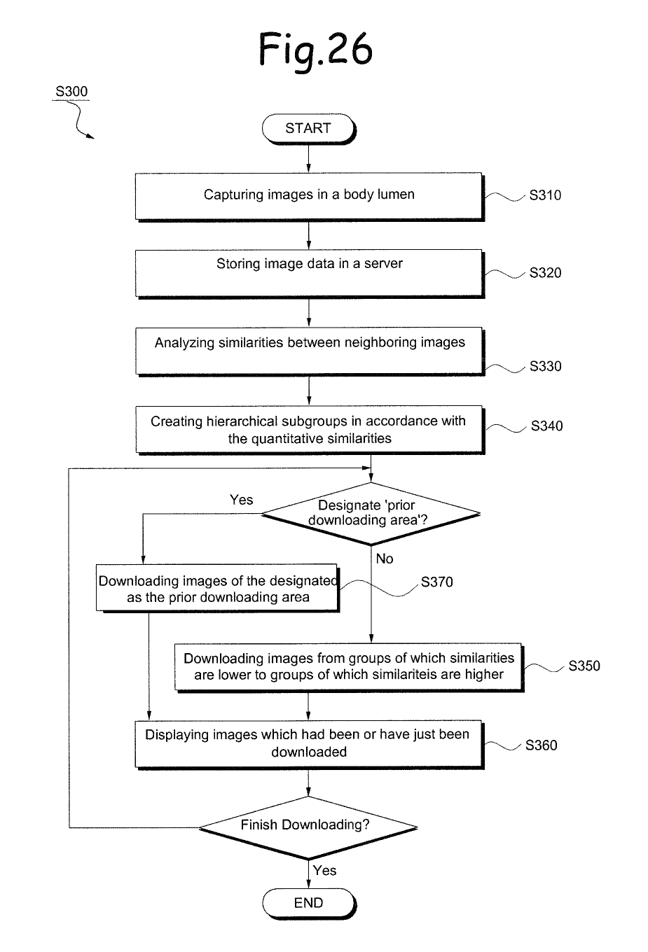

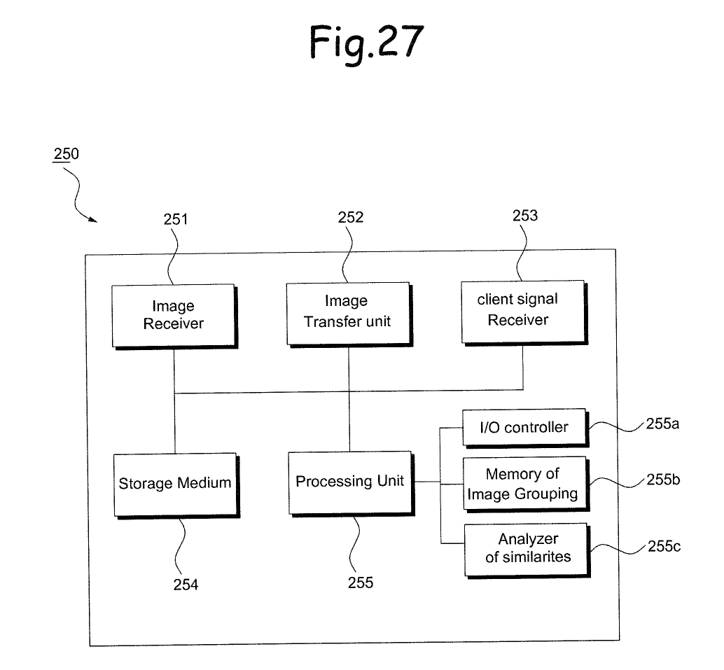

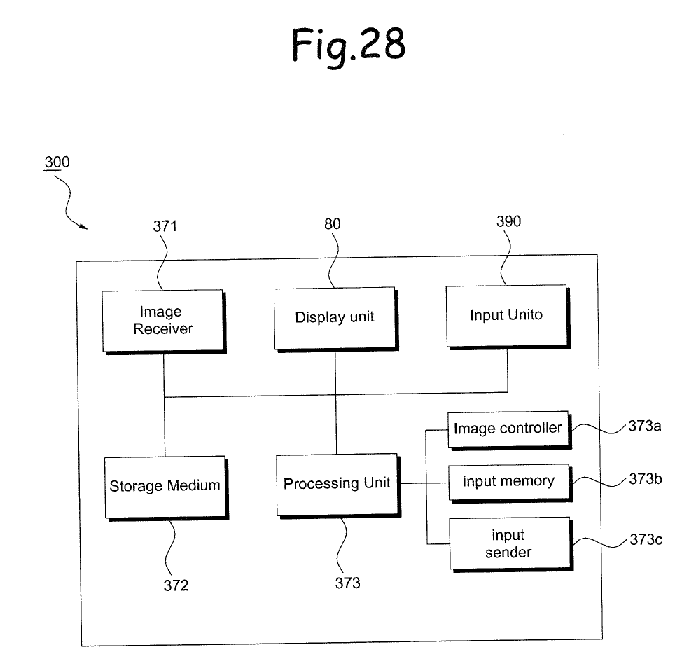

On the other hand, another embodiment of the present invention provides a method S300 of display processing images captured by an in-vivo imaging device 30 is illustrated in FIG. 26. The method S300 comprising a step of S310 of capturing original images in a body lumen 41 by an in-vivo imaging device 30, a step S320 of transferring the image date captured from the in-vivo imaging device 30 to the server 250 and of storing data of images in a storing medium, a step S330 of analyzing quantitative similarities between neighboring images which is stored in the storing medium, a step S340 of hierarchically classifying images into plural subgroups in accordance with the quantitative similarities of images in a server 250, a step S350 of normally downloading from a server 250 to at least one client 300, 300′ the image data in sequence from the group having images of the lowest similarities to the group having images of the highest similarities, a step S360 of firstly downloading images included in a prior downloading area 416 designated by a user during the step S350, a step S360 of displaying images which had been downloaded or have just been downloaded from the server 250 to the client 300, 300′. Herein, as illustrated in FIG. 26 the step S350 and the step S360 are repeated until all images are downloaded to the client 300, 300′.

The step S310 is performed by capturing images in a body lumen by a camera of an in-vivo imaging device 30 such as a capsule endoscope which moves through digestive organs.

The step S320 is performed by transferring image data captured by the in-vivo imaging device 30 to a receiver 60 through a general wireless communication such as RF communication or through a human body, by transferring image date from the receiver 60 to the server 250 through wire or wireless communication, and then by storing image data in a storage medium 254.

In the step S330, the analyzer 255c of a processing unit 255 in the server 250 quantitatively and numerically analyze the similarities between neighboring images. For example, in case that an in-vivo imaging device 30 captures twenty images in a body lumen as shown in the above table 1, the step S330 is performed by comparing and analyzing quantitative similarities with neighboring images. Herein, the similarity of the same images is analyzed as 100 by means of a normalization process.

In the step S340, based on the normalized quantitative similarities of images, all the images captured in a body lumen are classified into plural similar groups. Herein, the similar groups may be formed as one image.

The similar groups may be classified based on predetermined similarities such as a first group, a second group, a third group, . . . . Concretely, as the lower similarity means that the image is rapidly changed compared with the previous image, it is more efficient to download image of lower similarities prior to images of higher similarities (it means ‘the similar images’) because the images of lower similarities may comprise a summary of images captured in a body lumen and thus it will be more helpful for an examiner to check more promptly whether an examinee has disease-suspected symptoms.

In case of classifying plural similar groups from images listed in table 1 as an example, the first similar group may be set as having similarity less than 50, the second similar group may be set as having similarity between 50 and 80, the third similar group may be set as having similarity between 80 and 97, and the fourth similar group may be set as having more than 97. The result of the classified groups is as table 2.

TABLE 2

| | |
|---|---|
| 1^{st} group | Image #1, Image #2, Image #11, Image #19 |
| 2^{nd} group | Image #4, Image #9, Image #10, Image #12, Image #20 |
| 3^{rd} group | Image #3, Image #7, Image #8, Image #13, Image #14, Image |
| | #15, Image #18 |
| 4^{th} group | Image #5, Image #16, Image #17 |

The images collected in the first group has lowest similarities and thus are most dissimilar and characteristic in all the captured images. It means that an examiner is interested in the images in the first group, and thus, the images in the first group is firstly downloaded from the server 250 to the client 300 whereby an examiner can visually check the characteristic images which are most dissimilar with one another. During checking the images in the first group which had been downloaded or have been just downloaded, the images in the second group are downloaded from the server 250 to the client 300.

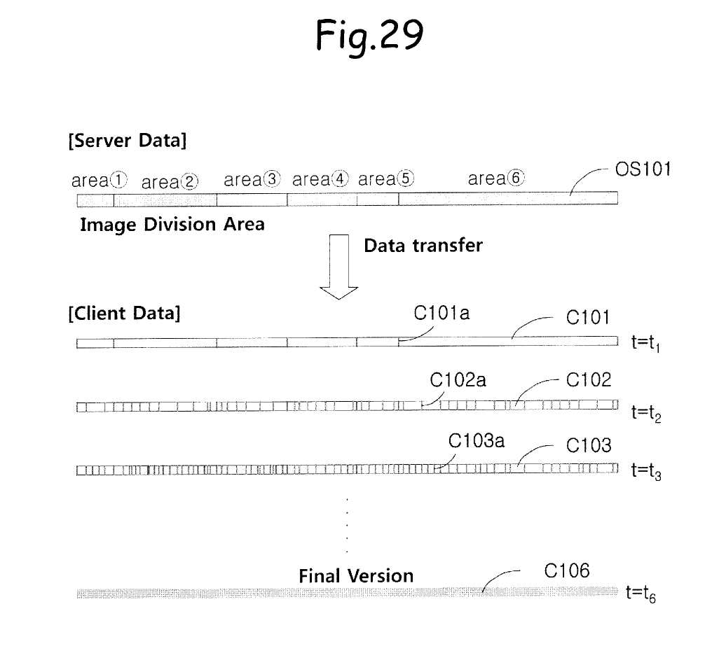

That is, as shown in FIG. 29, in the step S340, the original images OS101 stored in the storage unit 254 are classified into plural groups (i.e, six image division areas in the server such as area \textcircled{1}, area \textcircled{2}, area \textcircled{3}, area \textcircled{4}, area \textcircled{5}, and area \textcircled{6}) based on the similarities. Then, instead of downloading in capturing sequence from the server 250 to the client 300, at the stage of t=t1 which is earliest time of the downloading, the images having lowest similarities among the six image division area are firstly downloaded from the server 250 to the client 300. Thus, the locations C101a of the images in the first group (i.e., area \textcircled{1}) are indicated at t=t1 on the time bar C101 as a sign of downloading of the first group to the client 300. Thereafter, at the time of t=t2, the images in the second hierarchical group (i.e., area \textcircled{2}) are downloaded from the server 250 to the client 300, and then the locations C102a of the images in the second group (i.e., area \textcircled{2}) are indicated at t=t2 on the time bar C102 as a sign of downloading of the second group to the client 300. Also, at the time of t=t3, the images in the next third hierarchical group (i.e., area \textcircled{3}) are downloaded from the server 250 to the client 300, and then the locations C103a of the images in the third group (i.e., area \textcircled{3}) are indicated at t=t3 on the time bar C103 as a sign of downloading of the third group to the client 300. These procedures continues until the images in the last group (i.e., area \textcircled{6}) are downloaded from the server 250 to the client 300. When the images in the last group are downloaded to the client 300, the time bar C106 at the time of t=t6 is filled as a sign of downloading of all images. The groups of the images are memorized in the memory 255b of the processing unit 255.

On the other hand, the step S340 may be performed by analyzing correspondences of images for at least one event, and classifying the images into plural groups based on the correspondences for the event, and then by firstly downloading images having high correspondences for the event. It is useful to check an improvement of known or expected disease.

For example, in case of checking an improvement of an examinee who had a disease symptom of serious bleeding in a small intestine, and thus an in-vivo imaging device captures twenty images in digestive organs of the examinee, a doctor will be interested mostly whether bleeding has not stopped or not in the small intestine. Thus, correspondences for various events such as bleeding, polyp and ulcer may be quantitatively analyzed in the server 250 for the captured images, if an examiner input the event as ‘bleeding’, in the sequence of higher correspondences for the bleeding event the images are downloaded from the server 250 to the client 300.

Although lots of correspondences for various events are quantitatively analyzed for all images stored in the server 250, as bleeding event was input by an examiner, the quantitative correspondences for twenty images in the step S340 is obtained as following table 3.

TABLE 3

| Image No | Correspondence |
|---|---|
| Image #1 | 0.0 |
| Image #2 | 12.0 |
| Image #3 | 19.2 |
| Image #4 | 9.7 |
| Image #5 | 11.1 |
| Image #6 | 41.2 |
| Image #7 | 11.1 |
| Image #8 | 62.6 |
| Image #9 | 77.3 |
| Image #10 | 91.3 |
| Image #11 | 95.3 |
| Image #12 | 88.1 |
| Image #13 | 81.2 |
| Image #14 | 65.3 |
| Image #15 | 30.3 |
| Image #16 | 7.1 |
| Image #17 | 12.6 |
| Image #18 | 30.9 |
| Image #19 | 21.3 |
| Image #20 | 16.3 |

That is, it is an image #11 that has the highest correspondence for the bleeding event. Thus, the image #11 is firstly downloaded from the server 250 to the client 300 and is displayed on screen of the client 300. Then, the image #10 having the secondly highest correspondence for the bleeding event is secondly downloaded from the server 250 to the client 300 and is displayed on screen of the client 300. That is, by analyzing correspondences for the designated event and by downloading and displaying the images in sequence of higher correspondences among 120,000 images, different from the conventional method which has no choice but to lose time of downloading all images from server to clients, the present invention enable an examiner to directly examine from the image having highest correspondence to the images having lower correspondences for the designated event without losing downloading images, and thus the examiner firstly recognize the worst portion of digestive organs without delay from beginning of diagnosis thereby achieving the prompt and efficient diagnosis.

On the other hand, the images having different correspondences may be grouped based on the quantitative correspondences and then downloaded from a group gathering the images having higher correspondences to the other groups gathering the images having lower correspondences. For example, a first group is classified by the images having the correspondences over 90.0 and then firstly downloaded from the server 250 to the client 300, and a second group is classified by the images having the correspondences between 80.0 and 90.0 and then secondly downloaded from the server 250 to the client 300. Similarly, a third group is classified by the images having the correspondences between 60.0 and 80.0 and then thirdly downloaded from the server 250 to the client 300, and a fourth group is classified by the images having the correspondences less than 60. and then finally downloaded from the server 250 to the client 300. This classification can be expressed by the following table 4.

TABLE 4

| | |
|---|---|
| 1^{st} group | Image #10, Image #11 |
| 2^{nd} group | Image #12, Image #13 |
| 3^{rd} group | Image #8, Image #9, Image #14 |
| 4^{th} group | Image #1, Image #2, Image #3, Image #4, Image #5, Image |
| | #6, Image #7, Image #15, Image #16, Image #17, Image |
| | #18, Image #19, Image #20 |

After classifying the images as above, by firstly downloading the images in the first group having highest correspondences and by displaying the images as soon as the images are downloaded, an examiner can immediately check the images having higher correspondences for the event which the examiner designated. Also, while the examiner examines the images of the first group downloaded from the server 250, as the images of the second group are downloaded to the client 300, the examiner can also examine the images of the second group without delay after examining images of the first group. Therefore, it is advantageous that an examiner can check images without delay which was required for downloading all images, and that an examiner can immediately check the images which the examiner is interested in.

As described above, after the step S340 of classifying images into plural groups, as the step S350, images are downloaded from the first group gathering the images having higher correspondences for the designated event or having lower similarities with neighboring images to the other groups (i.e., the second group, the third group, . . . ) gathering the images having lower correspondences or having higher similarities. The step 350 is performed by an image transfer unit 252.

Also, as the location of the images downloaded from the server 250 are indicated on a time bar C101a, C102a . . . in real time, an examiner can recognize in real time where the downloaded images are located and how many images has been downloaded.

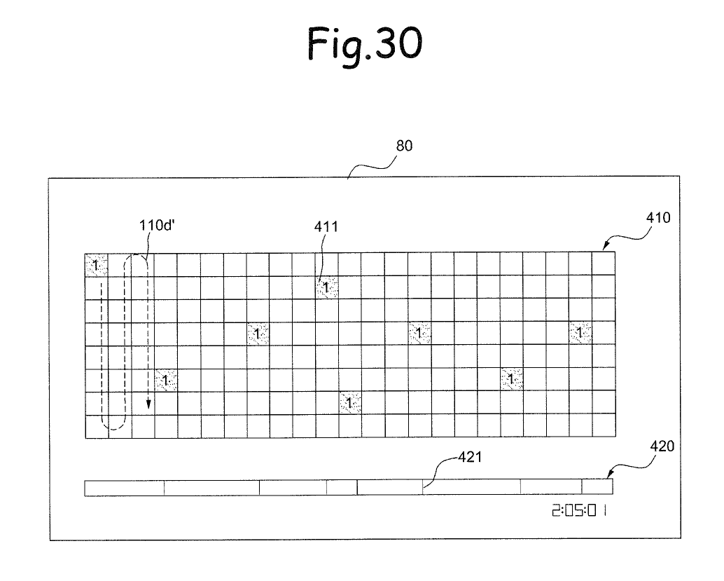

Substantially at the same time of the step S350 that images are downloaded from the server 250, as shown in FIG. 30., the step S360 is performed by displaying the downloaded images on at least one map view 410. Herein, the images which have been downloaded may be displayed as a larger view, as illustrated in FIGS. 30 to 33, it is desirable to display the downloaded images as reduced sized images on a map view 410 in that an examiner can easily recognize the locations and the numbers of the downloaded images in real time. Further, the examiner can enlarge the reduced images on the map view 410 for the detailed examination using the enlargement window 140 as illustrated in FIG. 4.

Concretely, the images classified in the step S340 into the first similar group having lowest similarities are downloaded from the image transfer unit 252 of the server 250 to the image receiver 371 of the client 300. Thus, as illustrated in FIG. 30, regardless of the capturing sequence 110d′ by an in-vivo imaging device 30, the images classified into the first similar group are firstly downloaded into the client 300 and then displayed as a map view 410 on screen 80 of the client 300. At the same time, as a reception condition that images in the first similar group are received to the client 250, indications 421 are indicated on the time bar 420. That is, the images of which change for the previous images are rapid are firstly downloaded to the client 300, and an examiner firstly can check the characteristic images among lots of captured images over 120,000. The screen display control is performed by an image controller 373a of the processing unit 370.

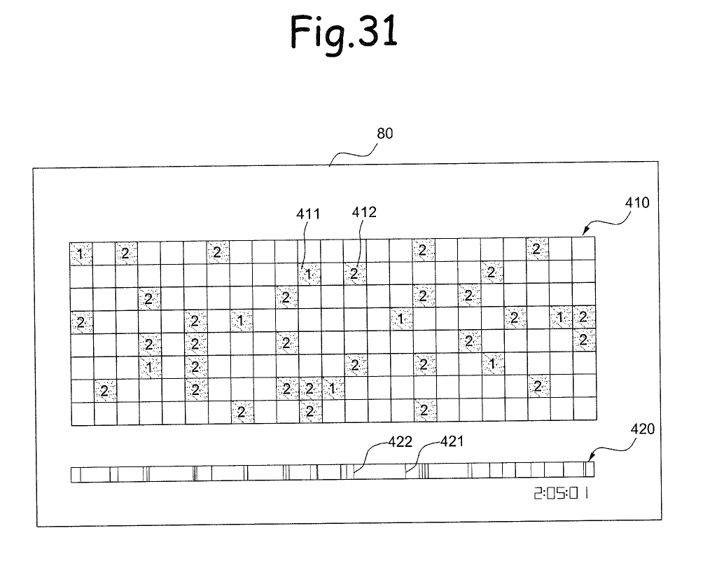

As illustrated in FIG. 30, all images 411 classified into the first similar group are downloaded from the server 250 to the client 300, the images 412 of the second similar group are downloaded which are classified as having lower similarities than the third similar group and classified as having higher similarities than the first similar group. Thus, as illustrated in FIG. 31, the images 412 of the second similar group are displayed as reduced sized images on the map view 410. At the same time, as a reception condition that images in the second similar group are received to the client 250, more dense indications 421, 422 are indicated on the time bar 420.

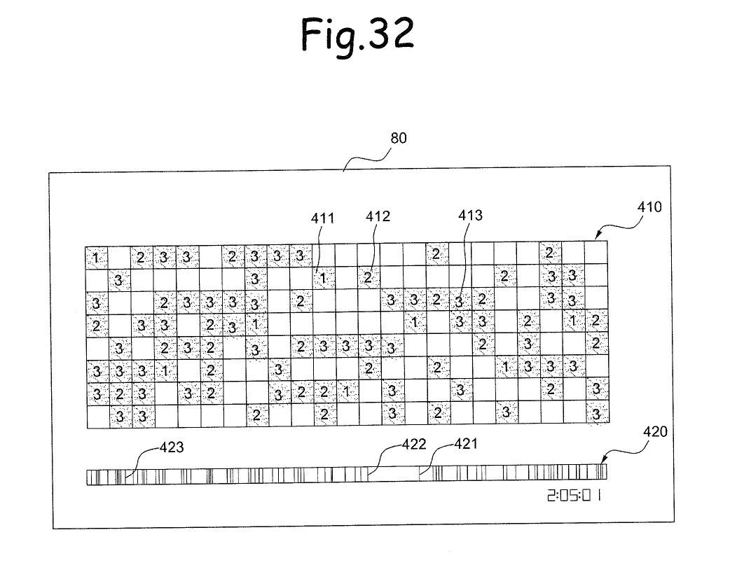

Thereafter, after all the images in the second similar group are downloaded from the server 250 to the client 300, the images 413 of the third similar group are downloaded which are classified as having lower similarities than the fourth similar group and classified as having higher similarities than the second similar group. Thus, as illustrated in FIG. 32, the images 413 of the third similar group are displayed as reduced sized images on the map view 410. At the same time, as a reception condition that images in the third similar group are received to the client 250, more dense indications 421, 422, 423 are indicated on the time bar 420.

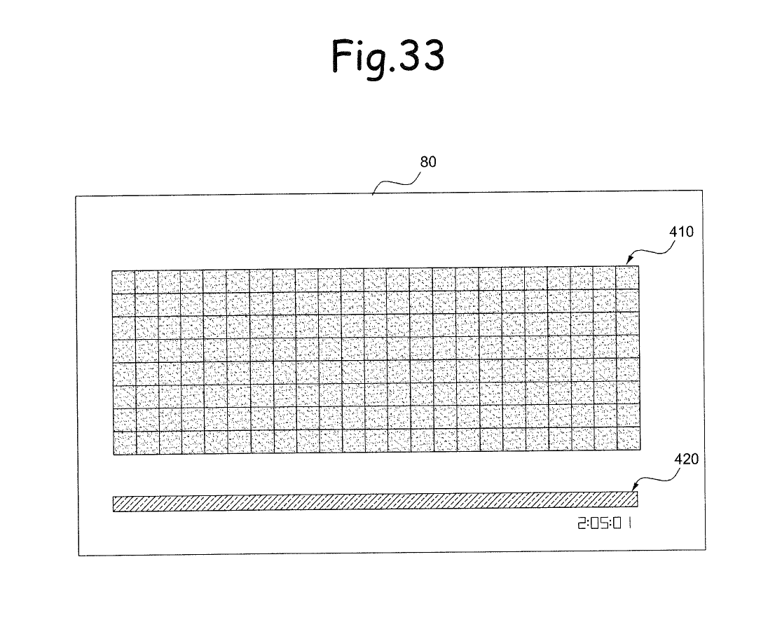

Similarly, after all the images in the third similar group are downloaded from the server 250 to the client 300, the rest of images in the next similar groups such as the fourth similar group, the fifth similar group . . . are sequentially downloaded to the client 300. Thus, as illustrated in FIG. 33, the map view 410 is filled as reduced sized images with the downloaded images from the server 250. At the same time, all area of the time bar 420 is also filled as the indications.

The above embodiment of the present invention has advantageous effects that an examiner does not need to wait for downloading all images as the conventional method and immediately examine the interested images and reach a diagnosis relating to the images thereby reducing a diagnosis time and enhancing the diagnosis efficiency.

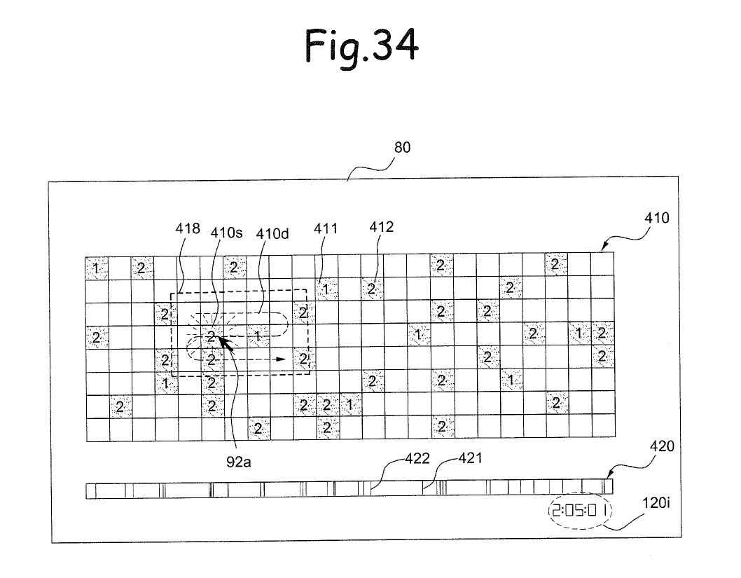

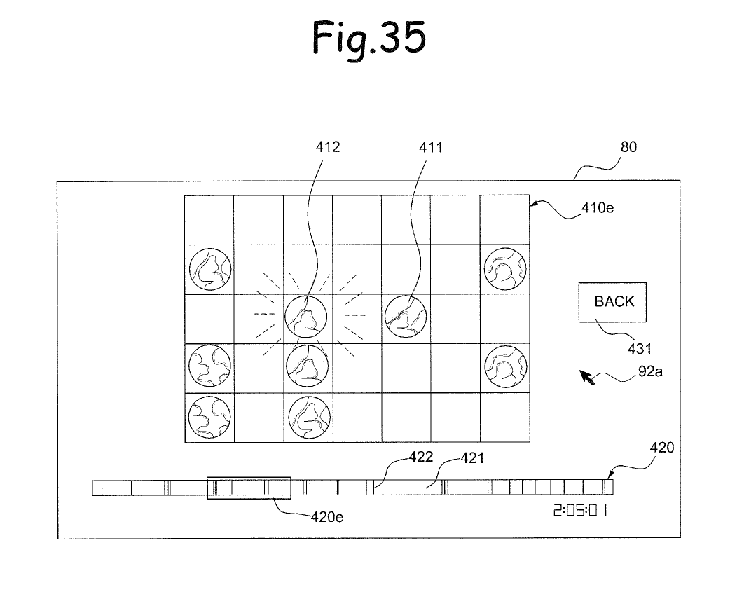

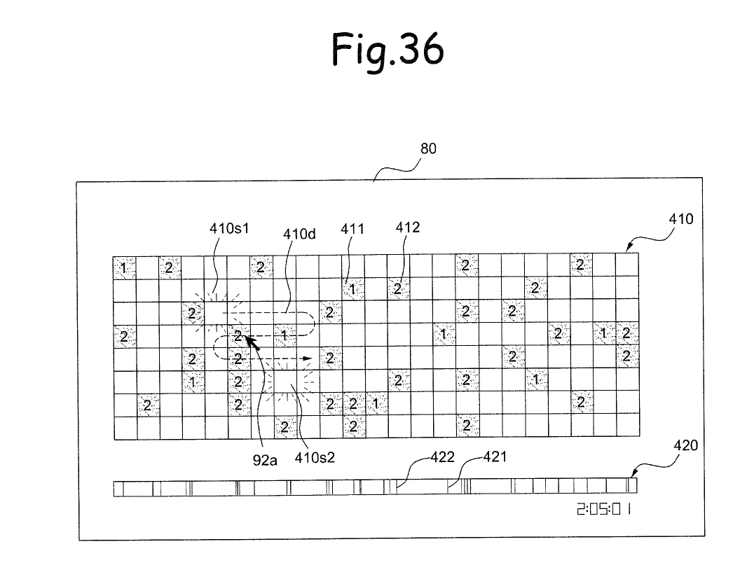

Herein, although about 120,000 images are displayed on a map view 410 as reduced sized of images, an examiner may not check and examine each image 411, 412 . . . of reduced size with naked eyes. Thus, as illustrated in FIG. 34, a portion of the map view can be enlarged for the designated block, for example, by selecting one image 410s with a mouse cursor 92a and then enlarging the selected image 410s including neighboring images 411, 412 in a enlarged map view 410e as shown in FIG. 35 by pressing predetermined keys such as ‘+’ key. As an examiner can examine the selected images 410s including the neighboring images 411, 412 on the enlarged map view 410e in FIG. 35, it is possible to accurate and correct diagnosis during the process of image downloading. Further, the enlarged map view 410e can be additionally enlarged so that the images are clearly viewed by calling original images or larger simplified images based on link information as explained with regard to FIG. 4. Therefore, the images on the map view 410 can be additionally enlarged step by step, for example, by repeatedly pressing ‘+’ key and thus, detailed examination can be performed on the map view 410, 410e during the process of the image downloading.

As illustrated in FIG. 35, when a portion of map view 410 is enlarged, it can be reversed from the enlarged map view 410e in FIG. 35 to the reduced map view 410, for example, by double clicking ‘back’ button 431.

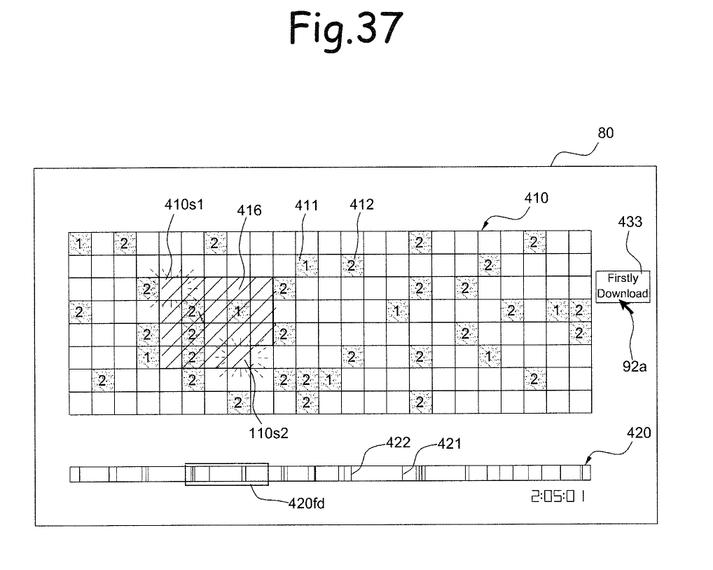

On the other hand, for example, when the images of the first group and of the second group are downloaded to the client 300, and when the images are displayed on a map view 410, an examiner may wishes to scan neighboring images near a specific image rather than just enlarging the images. Most of all, when an examiner found a disease-suspected image during the process of image downloading, the examiner much likes to check images near the disease-suspected image. In this case, the examiner can designate the ‘prior downloading area 416’ for firstly downloading images of the designated ‘prior downloading area’ than any other images, for example, by dragging for covering the ‘prior downloading area 416’ using mouse, or by double clicking using mouse cursor 92a two images 410s1, 410s2 which are located at the boundary of the ‘prior downloading area 416’ in FIG. 37 so as to include images in the arrangement order 410d.

Also, when the ‘prior downloading area’ is designated on the map view 410, the corresponding area 420fd is also indicated on the time bar 420. Thus, an examiner can easily recognize where the prior downloading area 416 is over the total digestive organs. At the same time, when the ‘prior downloading area’ is designated on the map view 410, the button 433 of ‘firstly download’ is activated as FIG. 37.

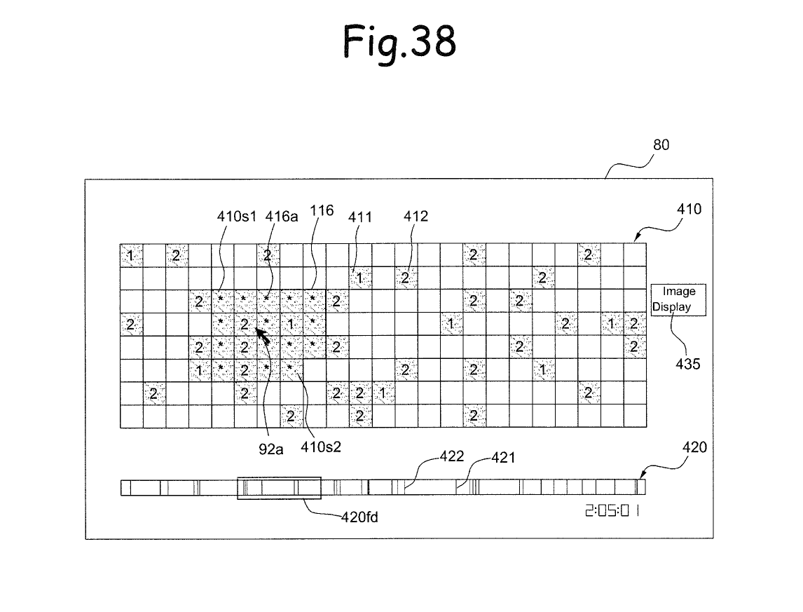

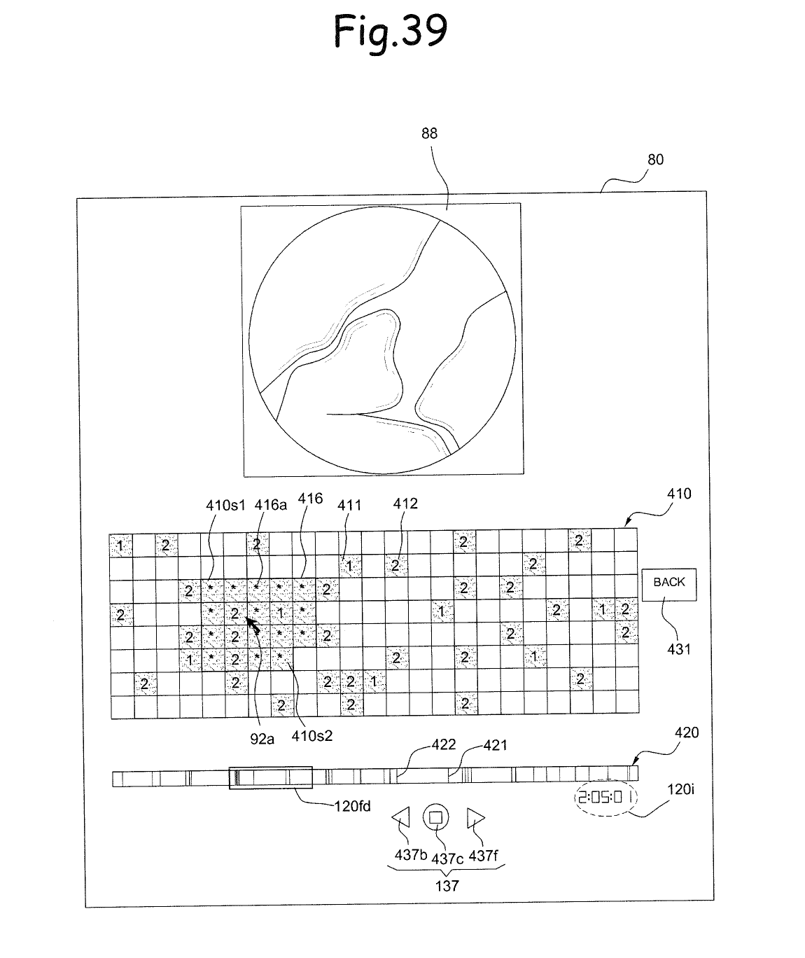

In case that an examiner clicked the button 433, the images which are to be filled with the ‘prior downloading area 416’ are firstly downloaded from the server 250 to the client 300. As the images of the prior downloading area 416 is the images the examiner is the most interested in, the examiner will examine the newly downloaded images first of all. When the downloading of the images in the ‘prior downloading area 416’ is finished, as illustrated in FIG. 38, the examiner can slowly play the images of the ‘prior downloading area 416’ on the large window 88 by clicking a button 435 of ‘image display’, which is activated when all the images of ‘prior downloading area 416’ are downloaded. Using control buttons 437 under the time bar 420, the examiner can control to play the firstly downloaded images such as operating playing button 437f, reverse playing button 437b and stop button 437c for scrutinizing the images of the ‘prior downloading area 416’.

That is, during the step S350, if a examiner designate the ‘prior downloading area 416’ the step S350 is halted until the images designated as the prior downloading area 416 are firstly downloaded to the client 300 (S360). Then, after the ending of the step S370, the step S350 is continued again. Herein, the image data downloaded into the client 300 using an image receiver 371 is saved in the storing medium 372. And an I/O controller of the server 250 receives the information of ‘prior downloading area 416’ from the input sender 373c and firstly transfer the images stored in the storage medium 254 to the client 300.

The step S370 is useful when an examiner found a characteristic disease-suspected image which is firstly downloaded in the step S350, and the examiner wishes to check the neighboring images in detail near the characteristic disease-suspected image, whereby the examiner examine disease-suspected images in more detail even during the downloading process. Herein, the prior downloading area 416 is saved by an input memory 373b and the information of the prior downloading area 416 is transferred from the client 300 to the sever 250 by an input sender 373c. Therefore, whenever an examiner designates the prior downloading area 416 at any time, the images of the prior downloading area 416 are immediately downloaded and displayed on screen so that the examiner can examine the images shortly, whereby an examiner does not need to wait for downloading all images as the conventional method and immediately examine the interested images and reach a diagnosis relating to the images.

As described above, as the method S300 of processing images in server/client system enables to firstly download and check images which are much changed compared with the previous images, an examiner can promptly and accurately diagnose without delay even during the process of image downloading. Further, while an examiner checks the images which are downloaded in sequence of lower similarities, when the examiner finds the downloaded images which is highly suspected disease symptom, the examiner can designate a prior downloading area 416 including the images 416a which the examiner is interested in and then firstly download the images 416a of the prior downloading area 416 in spite of the progress in the sequence, thereby enabling for the examiner to firstly check the interested images relating to disease symptoms as soon as possible.

Also, as an examiner examines the images which are hierarchically classified and downloaded, the diagnosis can be efficiently within a short time. Also, as the images downloaded from the server 250 are displayed on map view 410, and an examiner can enlarge a portion of the map view, the examiner can scan lots of images on the whole thereby enhancing the efficiency and promptness.

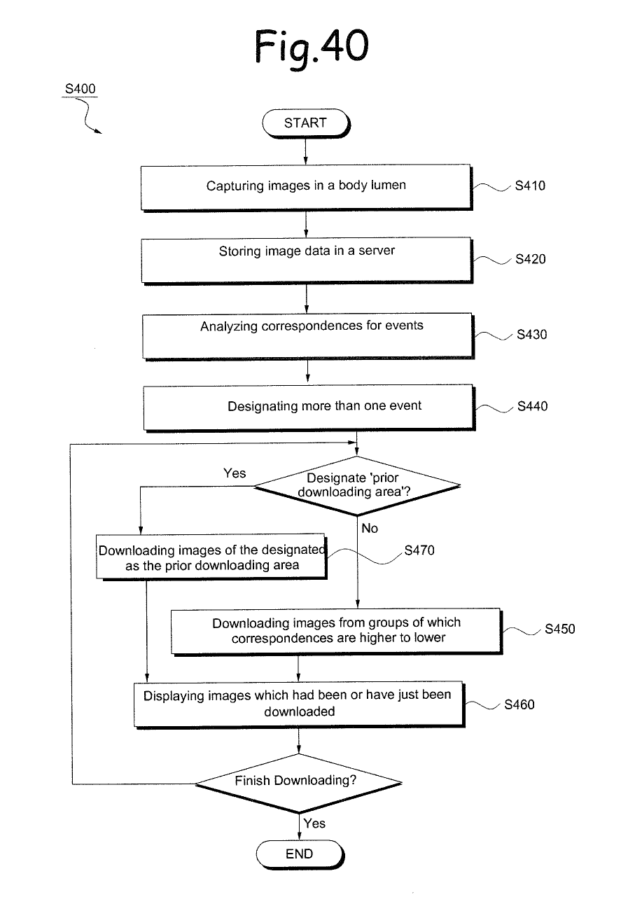

According to the other embodiment of the present invention, as illustrated in FIG. 40, the method S400 of displaying images comprises a step of S410 of capturing original images in a body lumen 41 by an in-vivo imaging device 30, a step S420 of transferring the image date captured from the in-vivo imaging device 30 to the server 250 and of storing data of images in a storing medium, a step S430 of analyzing quantitative correspondences for various events, a step S440 of inputting at least one designated event for deciding download sequence, a step S450 of hierarchically classifying images into plural subgroups in accordance with the quantitative correspondences of images in a server 250, a step S460 of normally downloading from a server 250 to at least one client 300, 300′ the image data in sequence from the group having images of the higher correspondences to the group having images of the lower correspondences, a step S470 of firstly downloading images included in a prior downloading area 416 designated by a user during the step S460, a step S480 of displaying images which had been downloaded or have just been downloaded from the server 250 to the client 300, 300′. Herein, as illustrated in FIG. 40 the step S46 and the step S470 are repeated until all images are downloaded to the client 300, 300′.

The step S410 and the step S420 are performed with the same with the step S310 and the step 320. In the step S430, the correspondences for various events are quantitatively analyzed by the processing unit 273 of the server 250.

The step S440 is performed what sequences will images be downloaded from the server 250 to the client 300. That is, as correspondences for various events were already analyzed in the step S430 over the images over 120,000, when a user designates one event or plural events at the client 300, the information the user designated at the client is transferred to the server 250 and then the user can download the images in sequence of higher correspondences to lower correspondences for the event which the user designated.

In the step S450, based on the designated events, all the images captured in a body lumen are classified into plural groups. Herein, the groups may be formed as one image.

After the step S430 of classifying images into plural groups and the step S440 of inputting the designated event, as the step S460, images are downloaded from the first group gathering the images having higher correspondences for the designated event to the other groups gathering the images having lower correspondences. during the step S450, if a examiner designate the ‘prior downloading area 416’ the step S450 is halted until the images designated as the prior downloading area 416 are firstly downloaded to the client 300 (S470). Then, after the ending of the step S470, the step S450 is continued again.

Substantially at the same time of the step S450 that images are downloaded from the server 250, the step S460 is performed by displaying the downloaded images on at least one map view 410. Herein, the images which have been downloaded may be displayed as a larger view, as illustrated in FIGS. 30 to 33 of the other embodiment, it is desirable to display the downloaded images as reduced sized images on a map view 410 in that an examiner can easily recognize the locations and the numbers of the downloaded images in real time. Further, the examiner can enlarge the reduced images on the map view 410 for the detailed examination using the enlargement window 140 as illustrated in FIG. 4.

On the other hand, according the other aspect of the present invention, a storing medium edible by a computer which saves encoded computer program for using the above described methods. The storing medium of the present invention may also include a guide manual for using the diverse functions mounted on a computer. Also, the storing medium may also include at least one or the combination of the program guide, data file, data structure and the likes. The medium and the program guide may be specially designed for the aim of the present invention, or may be known ones to ordinary skilled ones in the computer software art. The medium edible by computer may be hard-disks, floppy disks, optical medium such as magnetic tapes, CD-ROM, DVD or optical disks, ROM, RAM, flash memory, or any hardware apparatus, etc. for storing and executing the program of the methods. For example, the program guide may include electronic files containing machine code created by a compiler high-level codes executed by a computer. It is desired that the hardware apparatuses may be set as at least one software module to perform the above exemplary methods.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of displaying images obtained from an in-vivo imaging device, which comprises:
a step of receiving data of original images captured by an in-vivo imaging device in a body lumen;
a step of creating simplified images from the original images, the simplified images having lower resolution than the original images; and
a step of displaying at least one map view which has a plurality of columns and a plurality of rows, at least one part of the map view being filled with the plurality of the simplified images in rows and columns.

2. The method as claimed in claim 1, wherein the number of simplified images on the map view can be altered step by step in predetermined rate.

3. The method as claimed in claim 2, wherein the locations of the simplified images on the map view are rearranged based on either a column or a row on the map view so as to maintain the previous location order of the simplified images, when the number of the simplified imaged on the map view is altered.

4. The method as claimed in claim 3, wherein the simplified images are created as including a first set of simplified images and a second set of simplified images wherein the first set and the second set have different resolution each other; and wherein the simplified images from one set of the first set or the second set are displayed on the map view.

5. The method as claimed in claim 1, wherein a portion of all images to be displayed are displayed on the map view at a time, and then, the next portion of images to be displayed are displayed on the map view in a predetermined interval.

6. The method as claimed in claim 1, which further comprises:
a step of displaying an enlarged image for an image on the map view, the enlarged image being larger than the image on the map view.

7. The method as claimed in claim 1, which further comprises:
a step of displaying a sequence bar which shows the order of all images to be displayed; and
a step of marking the area on the sequence bar, of which the area corresponds to locations of images on the map view.

8. The method as claimed in claim 1, which further comprises:
a step of displaying a minimap bar which is formed of the combination of lots of the reduced size of the original images; and
a step of marking the area on the minimap bar, of which the area corresponds to locations of images on the map view.

9. The method as claimed in claim 1, which further comprises:
a step of dividing the images into a plurality of subgroups; and
a step of creating at least one representative image for each subgroup;
wherein the representative images are arrayed on the map view in the step of displaying.

10. The method as claimed in claim 9, wherein the step of dividing is performed so that every image in a subgroup falls within a predetermined similarity.

11. The method as claimed in claim 1, which further comprises:
a step of analyzing the correspondences for at least one event over the original images; and
a step of classifying the images having higher correspondences than the predetermined ones;
wherein the classified images are displayed on a map view in the step of displaying.

12. The method as claimed in claim 1, which further comprises:
a step of indicating annotation to the simplified images from a user.

13. A method of displaying images obtained from an in-vivo imaging device, which comprises:
a step of receiving data of original images captured by an in-vivo imaging device in a body lumen and forming an original image set;
a step of creating at least one simplified image set, the simplified images in the simplified image set having lower resolution than the original images in the original image set;
a step of displaying images on a map view which has a plurality of columns and a plurality of rows, the images on the map view being selected from one of the original image set or the simplified image set.

14. The method as claimed in claim 13, which further comprises:
a step of storing data of the simplified image set.

15. The method as claimed in claim 13, wherein at least two simplified image sets are created with different resolution.

16. The method as claimed in claim 13, wherein each image of the original image set is linked with each image of the simplified image set.

17. The method as claimed in claim 14, wherein the number of images on the map view is altered step by step at a predetermined rate, and wherein the images on the map view are selected from one of the plural simplified image sets.

18. The method as claimed in claim 17, wherein the locations of the images on the map view are rearranged based on either a column or a row on the map view so as to maintain the previous location order of the images, when the number of the simplified imaged on the map view is altered.

19. The method as claimed in claim 13, which further comprises:
a step of creating sub-map view from the map view.

20. An apparatus of displaying images obtained from an in-vivo imaging device, which comprises:
an image receiver of receiving data of original images captured by an in-vivo imaging device in a body lumen;
a processing unit of creating simplified images from the original images, the simplified images having lower resolutions than the original images; and
a display unit of displaying at least one map view which has a plurality of columns and a plurality of rows, at least part of blanks on the map view being filled with the plurality of the simplified images in rows and columns.
